(19) United States
(12) Patent Application Publication
(10) Pub. No.: US 2019/0325545 A1
(43) Pub. Date: Oct. 24, 2019

(54) TRANSPORTATION PLANNING DEVICE, TRANSPORTATION PLANNING METHOD, AND STORAGE MEDIUM STORING PROGRAM

(71) Applicant: NEC Corporation, Minato-ku, Tokyo (JP)

(72) Inventor: Hisaya WAKAYAMA, Tokyo (JP)

(73) Assignee: NEC Corporation, Minato-ku, Tokyo (JP)

(21) Appl. No.: 16/462,993

(22) PCT Filed: Dec. 1, 2016
(86) PCT No.: PCT/JP2016/085749

§ 371 Date: May 22, 2019

(51) Int. Cl. G06Q 50/28; G06Q 10/06; G06Q 10/04

(52) U.S. Cl. CPC G06Q 50/28; G06Q 10/04; G06Q 10/06315

(57) ABSTRACT

A transportation planning device according to an embodiment is configured to: derive a candidate of a transportation procedure of one or more transportation targets which are part or all of a plurality of resources, the transportation procedure being a procedure of changing an allocation of the plurality of resources from a first allocation to a second allocation; calculate a rating of the candidate, based on a chronological change in a benefit generated by the plurality of resources when the candidate is executed, the chronological change in the benefit being specified based on a time required for each of the one or more transportation targets to move to an individual transportation destination; and output information based on the rating.

### TECHNICAL FIELD

The present disclosure relates to planning for improving efficiency of matters.

### BACKGROUND ART

In a system related to a specific benefit, a problem of maximizing a generated benefit is called an optimization problem, a mathematical programming problem, or the like, and a calculation technique for the problem is widely put into practice.

For example, in a system in which workers split a plurality of processes and produce products, calculation processing of deriving an optimum allocation of workers in each process in order to maximize production efficiency, that is, a production amount of products, is one of mathematical programming problems. The aforementioned calculation processing is particularly called production planning or personnel placement planning. As a literature related to production planning, PTL 1 discloses a device for allocating operations to workers involved in a loading operation at a distribution warehouse. PTL 2 describes a method of leveling out workloads of workers.

By the way, as one of mathematical programming problems, a transportation problem which is a problem handling transportation of objects and optimization of efficiency is known. For example, a transportation problem (or a “transportation planning problem”) is a problem of finding a transportation plan minimizing a transport cost of articles in a system transporting the articles to each of a plurality of destinations of supply where consumers of the articles exist. For example, NPL 1 and NPL 2 describe solutions of transportation problems.

### CITATION LIST

### Patent Literature

PTL 1: Japanese Unexamined Patent Application Publication No. 2002-312445

PTL 2: Japanese Unexamined Patent Application Publication No. H3-217967

### Non Patent Literature

NPL 1: F. L. Hitchcock, “The distribution of a product from several sources to numerous localities,” Journal of Mathematics and Physics, vol. 20, pp. 224 to 230, 1941

NPL 2: Rubner, Yossi et al., “The earth mover's distance as a metric for image retrieval,” International journal of computer vision vol. 40, no. 2, pp. 99 to 121, 2000

### SUMMARY OF INVENTION

### Technical Problem

While an optimum personnel placement may be determined by personnel placement planning, a problem of determining how and which person needs to be transported in order to achieve the optimum personnel placement is another problem. In other words, it is also important to examine a transportation method (transportation plan, transportation procedure) of personnel in order to achieve a desired personnel placement.

Transport planning handles a problem related to transportation of things and generally aims at minimization of a cost of transportation itself. Accordingly, a solution handled by transport planning is not necessarily a solution that optimizes efficiency of an entire system. For example, in a case that effects at destinations of supply increase as goods are delivered earlier to their destinations, common transport planning does not include performing calculations from a viewpoint of increasing the sum of effects at the respective destinations of supply. Additionally, for example, transport planning does not consider a loss incurred by transportation of workers except for a cost of transportation itself.

In other words, in generally known transport planning, since an effect varying with a travel time being brought by a moving resource (a thing or a person) is not considered, an optimum solution is not provided from a viewpoint of overall efficiency of effects achieved as a whole. None of the related literatures disclose a content with sufficient examination of a case that a travel time of a resource moving for changing a resource allocation affects a benefit and efficiency of a system receiving an effect from the resource.

An object of the present disclosure is to provide a device, a method, a program, and the like deriving a more efficient transportation plan of resources moving for changing a resource allocation.

### Solution to Problem

A transportation planning device according to one aspect of the present invention includes: candidate derivation means for deriving one or more candidates of a transportation procedure of one or more transportation targets which are part or all of a plurality of resources, the transportation procedure being a procedure of changing an allocation of the plurality of resources from a first allocation to a second allocation; calculation means for calculating a rating of the derived candidate, based on a chronological change in a benefit generated by the plurality of resources when the candidate is executed, the chronological change in the benefit being specified based on a time required for each of the one or more transportation targets to move to an individual transportation destination; and output means for outputting information based on the rating.

A transportation planning method according to one aspect of the present invention includes: deriving one or more candidates of a transportation procedure of one or more transportation targets which are part or all of a plurality of resources, the transportation procedure being a procedure of changing an allocation of the plurality of resources from a first allocation to a second allocation; calculating a rating of the derived candidate, based on a chronological change in a benefit generated by the plurality of resources when the candidate is executed, the chronological change in the benefit being specified based on a time required for each of the one or more transportation targets to move to an individual transportation destination; and outputting information based on the rating.

A program according to one aspect of the present invention causes a computer to execute: candidate derivation processing for deriving one or more candidates of a transportation procedure of one or more transportation targets which are part or all of a plurality of resources, the transportation procedure being a procedure of changing an allocation of the plurality of resources from a first allocation to a second allocation; calculation processing for calculating a rating of the derived candidate, based on a chronological change in a benefit generated by the plurality of resources when the candidate is executed, the chronological change in the benefit being specified based on a time required for each of the one or more transportation targets to move to an individual transportation destination; and output processing for outputting information based on the rating. The program is stored in a computer-readable storage medium.

A transportation planning device according to one aspect of the present invention includes: candidate derivation means for deriving a candidate of a transition procedure in which situations of one or more transition targets which are part or all of a plurality of resources are changed, the transition procedure being a procedure of changing a combination of situations which the plurality of resources is in, from a first combination to a second combination; calculation means for calculating a rating of the derived candidate, based on a chronological change in a benefit generated by the plurality of resources when the candidate is executed, the chronological change in the benefit being specified based on a time required for each of the one or more transition targets to transition to individual transition destination of a situation; and output means for outputting information based on the rating.

### Advantageous Effects of Invention

The present invention can derive a more efficient transportation plan of resources moving for changing a resource allocation.

### BRIEF DESCRIPTION OF DRAWINGS

FIG. 1 is a block diagram illustrating a configuration of a transportation planning device according to a first example embodiment.

FIG. 2 is a schematic diagram illustrating a configuration example of a work system in a first case.

FIG. 3 is a schematic diagram illustrating a relationship between a section and a workflow.

FIG. 4 is a diagram illustrating efficiency information.

FIG. 5 is a schematic diagram illustrating a travel time between sections.

FIG. 6 is a diagram illustrating travel time information.

FIG. 7 is a diagram illustrating surplus-and-shortage information.

FIG. 8 is a diagram illustrating a concept of calculation by a calculation unit.

FIG. 9 is a diagram illustrating an example of a display of a transportation method.

FIG. 10 is an example of tree-structured data representing paths derived by a candidate derivation unit.

FIG. 11 is a flowchart illustrating an example of a procedure for generating tree-structured data as illustrated in FIG. 10.

FIG. 12 is a schematic diagram illustrating a travel time between sections in a second case.

FIG. 13 is a diagram illustrating efficiency information in the second case.

FIG. 14 is a diagram illustrating a concept of calculation by the calculation unit in the second case.

FIG. 15 is a schematic diagram illustrating a time required for a change in a travel time between sections and work efficiency of a process to affect a next process in a third case.

FIG. 16 is a diagram illustrating an example of calculation by the calculation unit in the third case.

FIG. 17 is a diagram illustrating an example of calculation by the calculation unit in the third case.

FIG. 18 is a diagram illustrating an example of calculation by the calculation unit in the third case.

FIG. 19 is a diagram illustrating efficiency information in a fourth case.

FIG. 20 is a diagram illustrating an example of calculation by the calculation unit in the fourth case.

FIG. 21 is a diagram illustrating a calculation result by the calculation unit in the fourth case.

FIG. 22 is a schematic diagram illustrating a configuration of an example of an application environment of a transportation planning device according to a second example embodiment.

FIG. 23 is a diagram illustrating a travel time of each rescue squad to each stricken place in a fifth case.

FIG. 24 is a diagram illustrating a loss per unit time at each stricken place in the fifth case.

FIG. 25 is a block diagram illustrating a configuration of a transportation planning device according to a third example embodiment.

FIG. 26 is a flowchart illustrating an operation flow in the transportation planning device according to the third example embodiment.

FIG. 27 is a block diagram illustrating a configuration of a transportation planning device according to a modified example.

FIG. 28 is a block diagram illustrating an example of hardware that achieves units according to example embodiments.

### EXAMPLE EMBODIMENT

In the present disclosure, derivation of a transportation method (transportation plan, transportation procedure) by which resources move in such a way that a resource allocation becomes an intended allocation is referred to as “transportation planning.”

Example embodiments of the present invention is described in detail below with reference to drawings.

### First Example Embodiment

First, a first example embodiment of the present invention is described. The first example embodiment presupposes a transportation planning device 11 performing transportation planning with respect to transportation of workers in an environment including a system in which operations are performed by workers at a factory or a warehouse. As is described later in Supplement, the assumed environment is an example, and there may be an example embodiment in which the transportation planning device 11 is applied to an environment other than the environment described in the present example embodiment.

The transportation planning device 11 derives a transportation method of workers, that is, a plan of which worker moves where. In particular, the transportation planning device 11 derives a transportation method expected to be better from a viewpoint of efficiency of an entire system affected by transportation of workers, in an example described below.

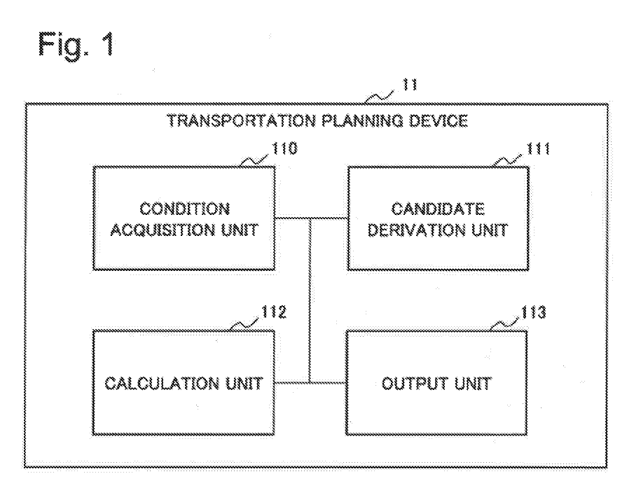

FIG. 1 is a block diagram illustrating a configuration of the transportation planning device 11. The transportation planning device 11 includes a condition acquisition unit 110, a candidate derivation unit 111, a calculation unit 112, and an output unit 113.

The condition acquisition unit 110 acquires information for executing transportation planning. Information for executing transportation planning is hereinafter also referred to as a “condition.”

The candidate derivation unit 111 derives a candidate of a transportation method of workers on the basis of information acquired by the condition acquisition unit 110.

The calculation unit 112 calculates a rating for each candidate derived by the candidate derivation unit 111. A rating is an indicator of validity of employment of the candidate. Specifically, a candidate with a higher rating is expected to be more suitable as a transportation method to be employed. For example, a rating is an indicator of efficiency (such as productivity) of a benefit acquired in an entire work process when a transportation procedure is executed on the basis of the candidate.

The output unit 113 outputs information based on a calculation result by the calculation unit 112.

Specific examples of processing by each unit in the transportation planning device 11 is described below with specific cases that may become targets of transportation planning by the transportation planning device 11 as examples. The cases described below are examples for facilitating understanding and do not necessarily imply that the transportation planning device 11 is applied only to these cases. Various conditions and premises may differ as long as a similar effect is provided.

### First Case

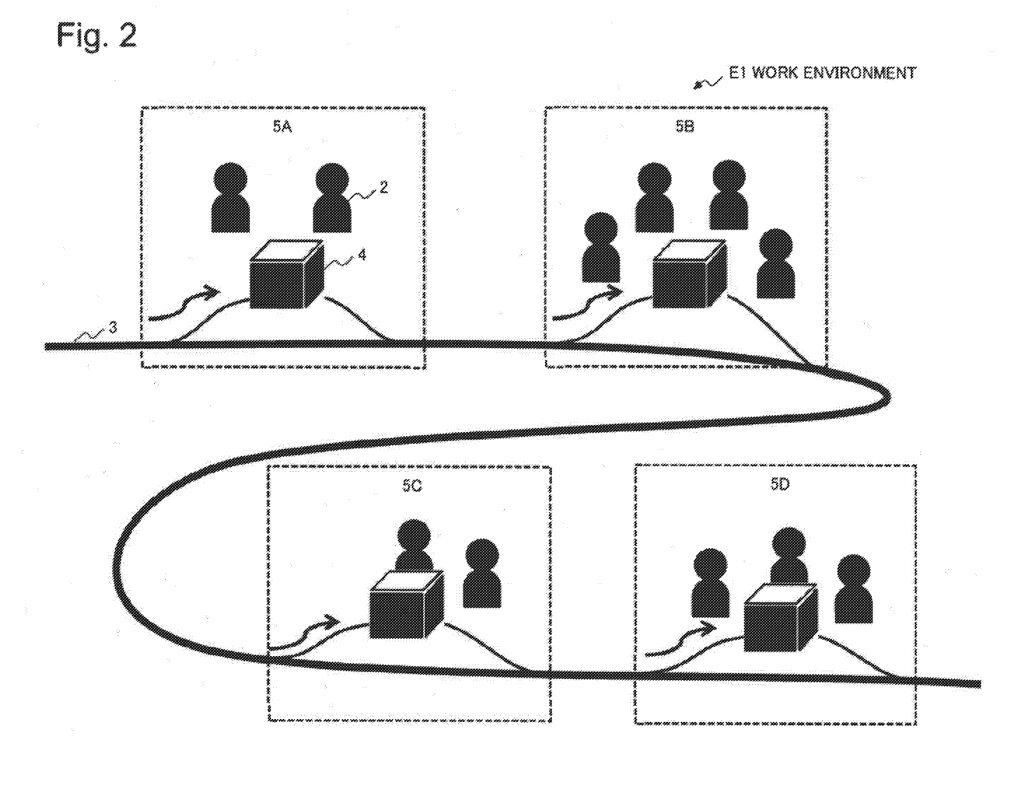

A first case illustrates a work environment E1 in which a picking operation in a delivery operation at a warehouse is performed. FIG. 2 is a schematic diagram illustrating a configuration example of the work environment E1.

In the work environment E1 in the first case, an operation called picking is performed on a container 4 transported by a conveyor 3. There are four sections 5A, 5B, 5C, and 5D, and workers 2 are allocated to sections. A worker 2 may be a person or a movable robot.

The conveyor 3 is separated into a main line and draw-in lines. The main line transports the container 4 from a section to another section. The draw-in lines are provided in relation to respective section and function to cause the container 4 to flow into each section. The container 4 passes through every section and is delivered to a downstream process.

When the container 4 arrives at a section, a worker 2 picks an item (designated item) to be put into the container 4 from, for example, a shelf existing in the section and puts the item into the container 4 after inspection. The picking operation is a so-called order picking operation. After the input of the item, the worker 2 returns the container 4 to the main line of the conveyor 3. The container 4 into which the item is put moves to a next section by the main line.

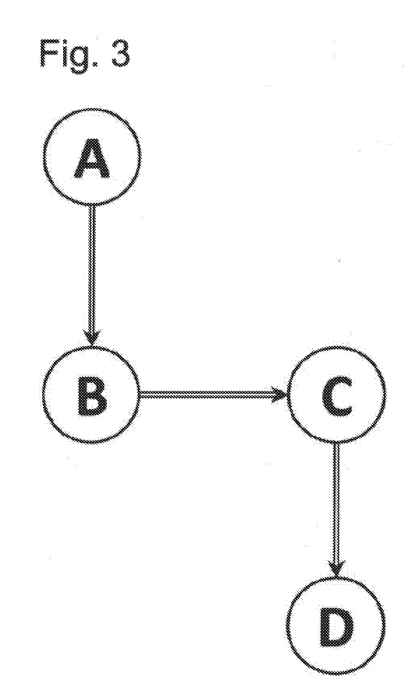

FIG. 3 is a schematic diagram illustrating a relationship between a section and a workflow in the work environment E1. As illustrated in FIG. 3, an operation is performed on the container 4 at each of the sections in an order of the section 5A→the section 5B→the section 5C→the section 5D in the work environment E1. The first case presupposes that a process in each of the sections is affected by a process in an immediately preceding section. Specifically, it is presupposed that in each process, a worker 2 cannot perform work with efficiency exceeding work efficiency in an immediately preceding process.

The first case presupposes that work efficiency in each of processes is immediately reflected in a next process.

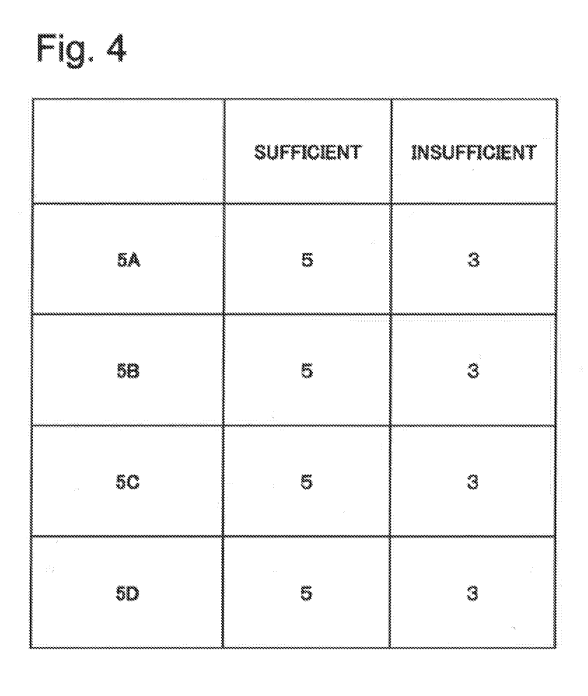

FIG. 4 is a diagram illustrating a table indicating work efficiency when the number of workers at each section is sufficient and work efficiency when the number of workers is insufficient. Information indicating a relation between the number of workers and efficiency at the section as illustrated in FIG. 4 is hereinafter referred to as “efficiency information.” The first case presupposes that at any section, when the number of workers is sufficient, work efficiency is “5” as long as work efficiency in an upstream process is “5” or greater, and when the number of workers is insufficient, work efficiency is “3.” For example, work efficiency is the number of containers 4 that can be processed per unit time. Another indicator may be used as work efficiency. Note that the following description presupposes that a greater value of work efficiency indicates better work efficiency.

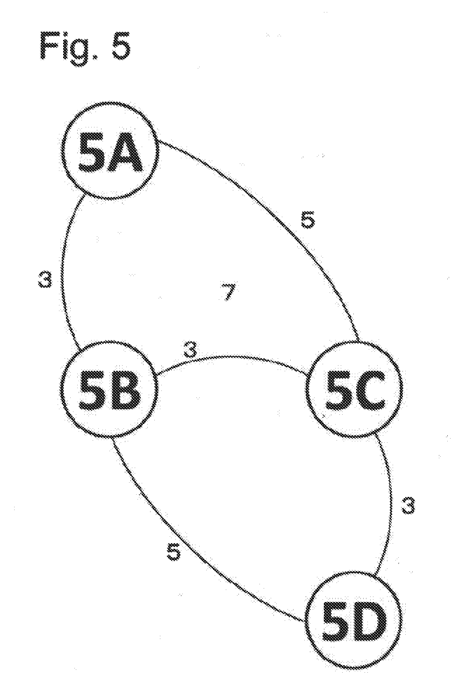

When a worker moves from a section to another section in the first case, the transportation requires time depending on a relation between the sections. FIG. 5 is a diagram illustrating a time required for a transportation between the respective sections. In FIG. 5, a number attached to a line connecting sections indicates a time required for a transportation between the sections (hereinafter referred to as a “travel time”, the unit of which is “minute”). For example, according to FIG. 5, a travel time between the section 5A and the section 5B is 3 minutes. A travel time between the section 5B and the section 5C, and a travel time between the section 5C and the section 5D is also 3 minutes. A travel time between the section 5A and the section 5C, and a travel time between the section 5B and section 5D is 5 minutes. A travel time between the section 5A and the section 5D is 7 minutes. Such information related to a time required for a transportation between the sections is referred to as travel time information. Travel time information may also be information indirectly indicating a travel time, such as a transportation distance.

A travel time according to the present example embodiment refers to a time required for a worker to transportation, that is, to work after changing a section where the worker works. In other words, a travel time may include a time required for suspending work for transportation and a time required for preparing for work at a transportation destination.

Further, the present example embodiment presupposes that a travel time between sections is constant irrespective of a direction; however, a travel time between sections may vary with a direction.

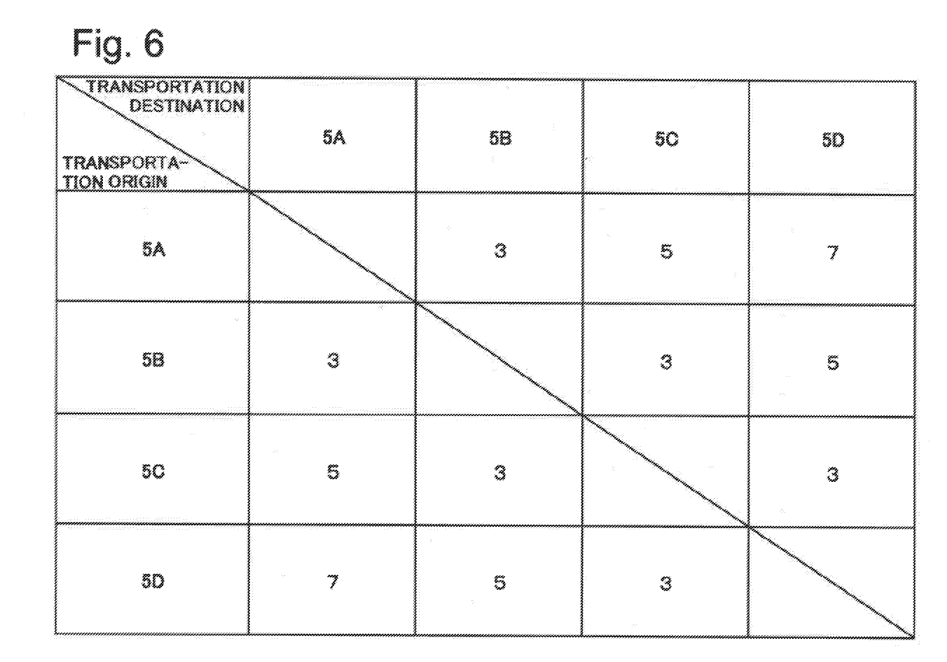

FIG. 6 illustrates relations between the travel times described above expressed by a table. In the table in FIG. 6, a cell related to a transportation origin section (for example, “5C”) and a transportation destination section (for example, “5D”) indicates a time required for a transportation from the transportation origin to the transportation destination (for example, “3”). The unit of a travel time is the “minute.”

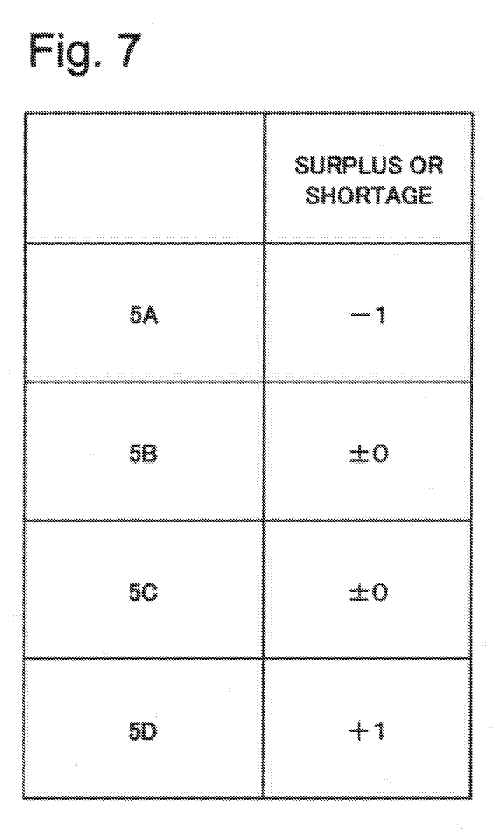

Here, assume that there are a section with a surplus of one or more workers and a section with a shortage of one or more workers. FIG. 7 illustrates an example of information indicating surplus or shortage in the number of workers (hereinafter referred to as “surplus-and-shortage information”) at each section.

In the example in FIG. 7, surplus or shortage in the number of workers is indicated with a plus sign in a case of surplus and is indicated with a minus sign in a case of shortage. According to the example in FIG. 7, there is a shortage of one worker in the section 5A; and on the other hand, there is a surplus of one worker in the section 5D. Further, there is no surplus or shortage of workers in the sections 5B and 5C.

Surplus and shortage refers to a deviation from an intended number of workers. An intended number of workers is, for example, the number of workers at each section in a most efficient allocation of workers. Intended numbers of workers at all sections in the first case are the number of workers allowing work efficiency to be “5”. Specifically, a state that there is a shortage of one worker refers to a state that brings work efficiency to “5” by increasing one worker. A state that there is a surplus of one worker refers to a state that can maintain work efficiency at “5” even when one worker is decreased.

When surplus and shortage as illustrated in FIG. 7 occurs, work efficiency is “3” at the section 5A. Further, the work efficiency at the section 5A affects the sections 5B, 5C, and 5D which are downstream processes of the section 5A, and work efficiencies at the sections are “3.” In order to improve efficiency of the entire process, it is desired that one worker at the section 5D transportation to the section 5A.

The information described above is information used for transportation planning by the transportation planning device 11 applied to the first case.

The condition acquisition unit 110 acquires various types of information described above as a condition. Specifically, the condition acquisition unit 110 acquires the workflow information illustrated in FIG. 3, the efficiency information illustrated in FIG. 5, the travel time information illustrated in FIG. 6, and the surplus-and-shortage information illustrated in FIG. 7. The information above may be previously input to the condition acquisition unit 110 or may be derived by the condition acquisition unit 110.

For example, the condition acquisition unit 110 may acquire a condition from a management system monitoring the work environment E1. For example, a management system is a system monitoring an allocation of workers, a flow of the container 4, stock status of items that will be put into the container 4, and the like by a surveillance camera, a computer, and the like. There may be a supervisor monitoring status of workers and giving instructions related to work to workers. Information used by the transportation planning device 11 may be input in part or in whole by the supervisor.

Further, for example, the condition acquisition unit 110 may specify a section with a surplus of workers and a section with a shortage of workers on the basis of acquired information. In order for the condition acquisition unit 110 to specify a section with a surplus of workers and a section with a shortage of workers, an intended allocation and a current allocation may be input to the condition acquisition unit 110. The condition acquisition unit 110 may derive an intended allocation. The condition acquisition unit 110 may specify a most efficient allocation of workers as an intended allocation on the basis of an entire number of workers in the work environment E1 and efficiency information. A most efficient allocation of workers is specifiable by, for example, a known production planning technique.

When all information becomes available, the candidate derivation unit 111 derives a candidate of a transportation method of workers on the basis of the acquired information.

### Derivation of Candidate

A transportation method of workers derived by the candidate derivation unit 111 is a transportation method satisfying the following requirements.
The transportation method causes the number of workers to be an intended number of workers at every section.
Each number of workers moving from a section does not exceed the number of movable workers at the section.

An intended number of workers is precisely the number of workers making a surplus or shortage be “±0.” On the basis of the example in the first case, the candidate derivation unit 111 derives a transportation method of workers in such a way that one worker is decreased from the section 5D, and one worker is increased at the section 5A. The candidate derivation unit 111 may specify a section where the number of workers should be increased and a section where the number should be decreased, on the basis of surplus-and-shortage information or on the basis of a current allocation and efficiency information.

On derivation of a transportation method by the candidate derivation unit 111, a limitation that the number of workers moving from each section does not exceed the number of movable workers at the section is provided. The number of movable workers at each section is determined by a method as described below.

Since there is shortage of workers at the section 5A at present, work in the section 5A is rate-determining. The section 5A is a so-called bottleneck in efficiency of the entire process. In other words, work efficiency at the section 5A affects the sections 5B, 5C, and 5D. From FIG. 7, a surplus or shortage of workers at each of the sections 5B, 5C, and 5D is ±0, ±0, and +1, respectively; however, there is practically a surplus of one more worker until a worker is filled at the section 5A which is the bottleneck. Accordingly, the number of movable workers at each of the sections 5B, 5C, and 5D becomes 1, 1, and 2, respectively. In other words, even when one worker leaves any of the section 5B and 5C, work efficiency does not change; and therefore transportation of one worker from each of the sections 5B and 5C is permitted. Even when two workers leave the section 5D, work efficiency does not change; and therefore transportation of two workers from the section 5D is permitted.

In other words, for example, the number of movable workers in the first case is determined by adding the number of workers in surplus or shortage at the section to an absolute value of the number of workers in shortage at a section with a shortage of workers.

Thus, the candidate derivation unit 111 counts in a worker in a position where the number of workers does not change between before execution of an allocation change and after the execution as a movable worker.

However, when a calculated number of movable workers exceeds an actual number of workers at a section, the number of movable workers is the actual number of workers at the section. The first case presupposes that the number of movable workers at each section as calculated above does not exceed an actual number of workers at the section.

Under the condition described above, for example, the candidate derivation unit 111 derives candidates of a transportation method of workers by which one worker is decreased from the section 5D and one worker is increased at the section 5A, by the following procedure.
(1) Derive paths connecting the section 5D which is a section with a surplus of workers and the section 5A which is a section with a shortage of workers. A section with a movable worker being zero cannot be passed through. Further, the same section cannot be passed through twice or more. Paths derived under the rule described above are “5D→5A,” “5D→5B→5A,” “5D→5B→5C→5A,” “5D→5C→5A,” and “5D→5C→5B→5A.”
(2) Derive transportation methods of one worker moving from a section other than an end point in a derived path to a next section on the path.

### Specifically,

On the basis of the path “5D→5A,” a transportation method (I) in which one worker moves from the section 5D to the section 5A is derived.
On the basis of the path “5D→5B→5A,” a transportation method (II) in which one worker moves from the section 5D to the section 5B, and one worker moves from the section 5B to the section 5A is derived.
On the basis of the path “5D→5B→5C→5A,” a transportation method (III) in which one worker moves from each of the sections 5D, 5B, and 5C to the sections 5B, 5C, and 5A, respectively, is derived.
On the basis of the path “5D→5C→5A,” a transportation method (IV) in which one worker moves from the section 5D to the section 5C, and one worker moves from the section 5C to the section 5A is derived.
On the basis of the path “5D→5C→5B→5A,” a transportation method (V) in which one worker moves from each of the sections 5D, 5C, and 5B to the sections 5C, 5B, and 5A, respectively, is derived.

It is presupposed that moves of workers in each transportation method is simultaneously performed. Depending on a case, the candidate derivation unit 111 may derive a transportation method in which workers moving at shifted timings as another candidate. It is pointless in the first case that workers transportation at shifted timings, and therefore the candidate derivation unit 111 does not need to derive a transportation method including such a transportation.

Out of derived transportation methods, the candidate derivation unit 111 may exclude an evidently inefficient transportation method from candidates. In the first case, the transportation method (III) is evidently inefficient. The reason is that one worker can move from the section 5B to the section 5A within a time in which one worker moves from the section 5C to the section 5A. For instance, a procedure of one worker moving from the section 5B to the section 5C is denoted as a procedure ‘a1’, a procedure of one worker moving from the section 5C to the section 5A is denoted as a procedure ‘a2’, and a procedure of one worker moving from the section 5B to the section 5A is denoted as a procedure ‘b’. At this time, when a procedure of simultaneously performing the procedure ‘a1’ and the procedure ‘a2’ is denoted as a procedure ‘a’, and the procedure ‘a’ and the procedure ‘b’ are compared, in a case that a time required for the procedure ‘a2’ is longer or equivalent compared with a time required for the procedure ‘b’, the procedure ‘a’ is a more inefficient procedure than the procedure ‘b’. The reason can be described on the basis of the following premise.

Premise: When attention is focused solely on one worker moving to a certain transportation destination, as the worker arrives at the transportation destination at an earlier time, a benefit brought by the worker at the transportation destination becomes greater (at least not less than that in case the worker arrives at a later time). In other words, with regard to a transportation by one worker with a fixed transportation origin and a fixed transportation destination, a shorter travel time is better.

On the basis of the premise, the procedure ‘a1’ is more inefficient than an imaginary procedure ‘a3’ of “moving from the section 5B to the section 5C in 0 seconds.” Accordingly, the procedure ‘a’ is more inefficient than a procedure of simultaneously performing the procedure ‘a2’ and the imaginary procedure ‘a3’. Then the procedure of simultaneously performing the imaginary procedure ‘a3’ and the procedure ‘a2’ is precisely equivalent to an imaginary procedure ‘c’ of one worker moving from the section 5B to the section 5C in 0 seconds and then moving from the section 5C to the section 5A. The imaginary procedure ‘c’ is more inefficient than the procedure ‘b’. The reason is that a travel time from the section 5C to the section 5A is not shorter than a travel time from the section 5B to the section 5A.

As described above, when a travel time from a second section to a first section is not longer than a travel time from a third section to the first section, a transportation method including a transportation procedure of “one worker moving from the second section to the third section and one worker moving from the third section to the first section” is an evidently inefficient transportation method (that is, obviously not a candidate with the highest rating). Accordingly, the candidate derivation unit 111 may exclude such a transportation method from candidates. In the example in the first case, the candidate derivation unit 111 may exclude the transportation method (III) from candidates.

The candidate derivation unit 111 may exclude a path from which an obviously inefficient transportation method is derived from calculation in a path derivation stage. Specifically, when a travel time to a certain section included in a path from a section immediately preceding the certain section is longer than or equal to a direct travel time from a section preceding the immediately preceding section to the certain section, a transportation method does not need to be derived from such a path. The candidate derivation unit 111 does not need to derive such a path itself.

An example of a specific method of deriving a path while excluding an obviously inefficient path is described later in Supplement [5].

According to the above, transportation methods derived by the candidate derivation unit 111 as candidates are the transportation methods (I), (II), (IV), and (V).

### Calculation of Rating

For each derived candidate, the calculation unit 112 calculates a rating of the candidate. For example, the calculation unit 112 calculates, as a rating, efficiency of an entire process within an arbitrary time period including a time period from a start of a transportation to completion of the transportation. On calculation of efficiency, the calculation unit 112 uses surplus-and-shortage information, travel time information, and the efficiency information illustrated in FIG. 4.

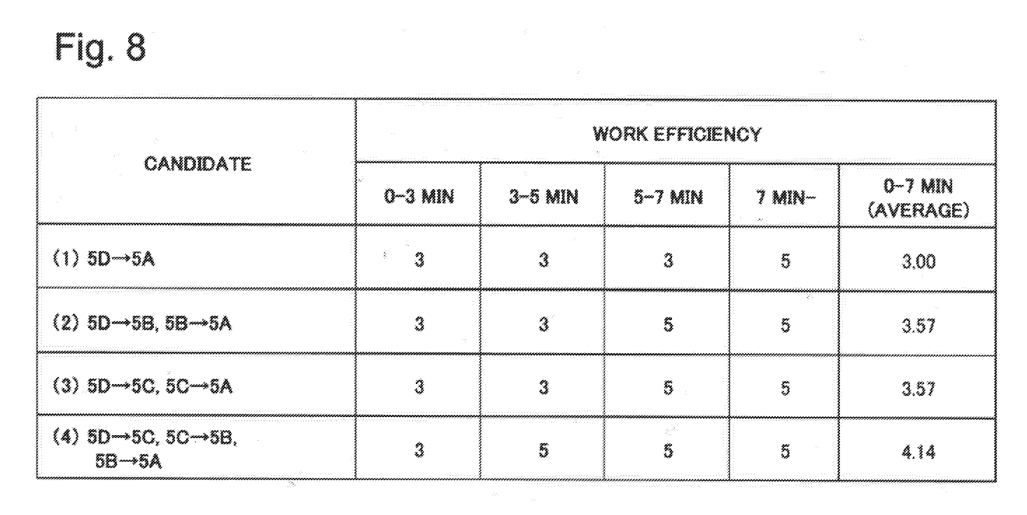

FIG. 8 is a diagram illustrating a concept of calculation by the calculation unit 112. As illustrated in FIG. 8, for each candidate, the calculation unit 112 derives a chronological change in efficiency of the entire process when the candidate is employed.

In columns under “CANDIDATE” in the table in FIG. 8, four candidates derived by the candidate derivation unit 111 are described. In each column under “WORK EFFICIENCY” in the table in FIG. 8, work efficiency of the entire process for each elapsed time from a start of a transportation by a worker when each candidate is employed is described.

A candidate (1) is a transportation method of one worker moving from the section 5D to the section 5A. When the transportation method by the candidate (1) is executed, the number of workers at the section 5A which is a bottleneck is filled 7 minutes after the start of the transportation of the worker. Accordingly, work efficiency from 0 to 7 minutes is “3.” The number of workers at the section 5A is filled and the transportation is completed at the point when 7 minutes elapses, and therefore the work efficiency is improved to “5.”

A candidate (2) is a transportation method of one worker moving from the section 5D to the section 5B and one worker moving from the section 5B to the section 5A. The number of workers at the section 5A which is a bottleneck is filled 3 minutes after the start of the transportation of the worker in the transportation method by the candidate (2). Accordingly, work efficiency from 0 to 3 minutes is “3.” The number of workers at the section 5A is filled at the point when 3 minutes elapses; however, the number of workers at the section 5B temporarily enters a state with a shortage of one worker. Accordingly, the section 5B becomes a bottleneck, and the work efficiency remains at “3” until the number of workers at the section 5B is filled. A transportation for filling the number of workers at the section 5B is the transportation of a worker from the section 5D to the section 5B; and the transportation is completed 5 minutes after the start of the transportation. Accordingly, the work efficiency from 3 to 5 minutes is “3,” and the work efficiency after 5 minutes becomes “5.”

A candidate (3) is a transportation method of one worker moving from the section 5D to the section 5C and one worker moving from the section 5C to the section 5A. The number of workers at the section 5A which is a bottleneck is filled 5 minutes after the start of the transportation of the worker in the transportation method by the candidate (3). Accordingly, work efficiency from 0 to 5 minutes is “3.” While the transportation from the section 5D to the section 5C is simultaneously performed during the period, there is no change at the section 5A being the bottleneck; and therefore the transportation does not affect the work efficiency. Since the transportation is completed (the transportation from the section 5D to the section 5C is also completed) at the point when 5 minutes elapses, the work efficiency is thereafter improved to “5.”

A candidate (4) is a transportation method of one worker from each of the sections 5D, 5C, and 5B moving to the sections 5C, 5B, and 5A, respectively. The number of workers at the section 5A which is a bottleneck is filled 3 minutes after the start of the transportation of the worker in the transportation method by the candidate (4). Accordingly, work efficiency from 0 to 3 minutes is “3.” Further, while the transportation from the section 5D to the section 5C and the transportation from the section 5C to the section 5B are simultaneously performed during the period, there is no change at the section 5A which is the bottleneck; and therefore the moves do not affect the work efficiency. Since the transportation is completed (the transportation from the section 5D to the section 5C and the transportation from the section 5C to the section 5B are also completed) at the point when 3 minutes elapses, the work efficiency is thereafter improved to “5.”

As described above, the calculation unit 112 calculates work efficiency for each candidate at least up to 7 minutes after the start of the transportation. The work efficiency after 7 minutes is the same for every candidate.

The calculation unit 112 may determine an average of work efficiency from a start of a transportation to 7 minutes after the start for each candidate. Determining averages for the example described above, efficiency for each of the candidates (1) to (4) becomes 3.00, 3.57, 3.57, and 4.14, respectively. The average of work efficiency during 7 minutes is an example of a rating of each candidate.

### Output of Result

As a result of the calculation processing by the transportation planning device 11, the output unit 113 outputs information based on a rating calculated by the calculation unit 112.

For example, the output unit 113 may output a list of derived candidates and ratings of the respective candidates. An output rating may be a second rating generated on the basis of a first rating calculated by the calculation unit 112. For example, a second rating may be a deviation value of each candidate based on a value of a first rating of the candidate. A second rating may be a symbol determined according to a magnitude of a first rating, such as “S” or “A.”

For example, the output unit 113 may output information specifying a candidate with the highest rating out of derived candidates as a “transportation method that should be executed.” In the first case, since efficiency of the candidate (4) is highest, the output unit 113 outputs information specifying the transportation method by the candidate (4) as a “transportation method that should be executed.” For example, the output unit 113 displays the transportation method by the candidate (4) through a screen. Consequently, for example, a supervisor supervising the work environment E1 views the screen and recognizes the transportation method derived by the transportation planning device 11.

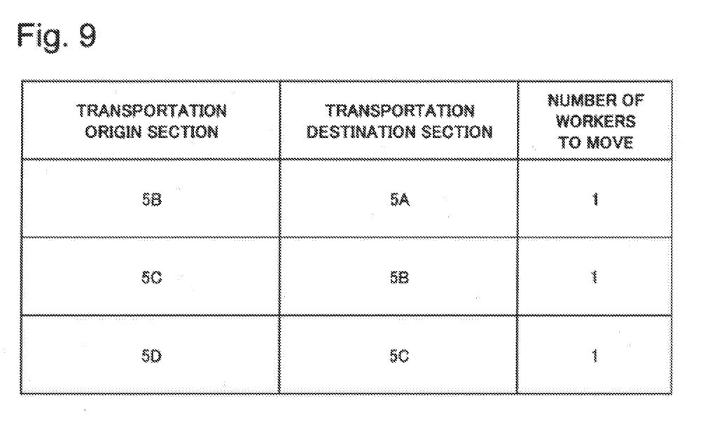

FIG. 9 is an example of a display of a transportation method by the output unit 113. For example, a transportation method is represented by a list of a set of a transportation origin section, a transportation destination section, and the number of moving workers, as illustrated in FIG. 9. The example in FIG. 9 indicates that one worker should move from the section 5D to the section 5C, one worker should move from the section 5C to the section 5B, and one worker should move from the section 5B to the section 5A. In the example in FIG. 9, one worker at each of the sections 5B, 5C, and 5D is, so to speak, a “transportation target.”

The output unit 113 may display a transportation method as an instruction. For example, the output unit 113 may display a text such as “one worker to move from the section 5D to the section 5C.”

In addition to a display by a screen, output of information by the output unit 113 may be performed by printing on paper, a method by sound, or a method by blinking light.

A person receiving an output (such as a supervisor) can determine a worker to move at each section on the basis of the output information and give a transportation instruction to the determined worker.

In place of the number of workers to move, the output unit 113 may output an identifier (such as a name or an identification number) of a worker. In other words, the output unit 113 may designate a transportation target. For example, the output unit 113 may derive one of workers at the section 5B and display an identifier of the worker in association with a display of the section 5C. By determining a worker to move by the output unit 113, a load of selecting a worker to move by a supervisor can be lightened.

The output unit 113 may directly output an instruction to a worker in such a way that the worker moves in accordance with a derived transportation plan. For example, the output unit 113 may instruct one of workers at the section 5D to move to the section 5C. Various forms of instruction method such as display of an identifier on a monitor installed at a section, an instruction by sound, and output of information to equipment individually held by a worker may be employed. Directly giving an instruction to a worker by the output unit 113 eliminates a need for selecting a worker to move by a supervisor.

### Effect

The transportation planning device 11 can derive an optimum transportation method from a viewpoint of efficiency of an entire process.

Normally, when a worker leaves a section accompanying a transportation, work efficiency at the section declines. However, in a case that a bottleneck exists, temporary work efficiency may not change even when a worker leaves the section. The transportation planning device 11 in the first case extracts a section as a section where a movable worker exists even when the section does not have a surplus of workers, as long as temporarily decreasing a worker from the section is determined not to affect the entire process. Specifically, for example, the transportation planning device 11 determines the number of movable workers at a section without a shortage of workers on the basis of the number of workers in shortage at a section with a shortage of workers. Consequently, the transportation planning device 11 can more diversely derive a transportation method of workers for resolving a shortage of workers.

Then, the transportation planning device 11 can devise an optimum transportation method on the basis of work efficiency in a state of a transportation method being executed or a so-called transient state. The reason is that for each derived candidate, the calculation unit 112 calculates work efficiency during execution of the transportation method on the basis of efficiency information, and calculates a rating. Outputting a transportation method by the output unit 113 on the basis of the rating allows a worker to move by a most efficient transportation method.

In particular, in an environment where work is continuously performed, status of poor work efficiency continues longer as more time is spent on deriving a transportation method. In such status, the transportation planning device 11 is expected to derive a suitable transportation method within a sufficiently short time. In other words, the transportation planning device 11 may provide a remarkable effect that a transportation of a worker can be suitably controlled in real time particularly with respect to a process in which an operation is in progress.

### Supplement

### [1] Mode of Calculation Target

While an environment including a system performing order picking is cited as an example of the work environment E1 in the first case, a target environment of transportation planning by the transportation planning device 11 is not limited to the environment including a system performing order picking.

For example, efficiency of an entire process varies by difference in a transportation method of workers in also a system performing relay-type picking or a system performing cart-type picking. Accordingly, application of the transportation planning device 11 to an environment including such a system can also provide a transportation method allowing more suitable work efficiency of an entire process on reallocation of workers.

Further, the transportation planning device 11 is applicable to various environments including a plurality of processes, such as a warehousing operation at a warehouse, a production process and an assembly process at a factory, a production process at a plant, loading and unloading of cargo at a harbor, and supply chain management including entry and exit of trucks.

In other words, the transportation planning device 11 may be applied to every case similar to the case described in the present disclosure.

### [2] Rating

A rating calculated by the calculation unit 112 is not limited to a numerical value directly indicating work efficiency. For example, the calculation unit 112 may calculate, as a rating, the number of containers 4 on which work at each section is completed in seven minutes.

Further, since the first case presupposes that work efficiency in an upstream process is immediately reflected in a downstream process, high work efficiency is essentially equivalent to a time required for the number of workers at every section to become an intended allocation being short. Accordingly, for example, the calculation unit 112 may determine a reciprocal of the time required for the number of workers at every section to become an intended number of workers as a rating. In this case, a higher rating, that is, the aforementioned time being shorter, also represents higher efficiency.

### [3] When Surplus or Shortage of Two or More Workers Exists

In the first case, a case that each of the number of workers in surplus and the number of workers in shortage is one is illustrated. An example of a derivation method of candidates by the candidate derivation unit 111 when each of the number of workers in surplus and the number of workers in shortage is two or more is described here.

For example, the candidate derivation unit 111 may assume a problem of resolving surplus and shortage as a combination of two or more problems of resolving surplus and shortage. A specific description is as follows.

It is presupposed as an example that in the work environment E1, each of the sections 5A and 5B has a shortage of one worker, and each of the section 5C and 5D has a surplus of one worker. Information indicating such surplus and shortage status is referred to as original surplus-and-shortage information.

In this case, the candidate derivation unit 111 divides the original surplus-and-shortage information. Specifically, for example, the candidate derivation unit 111 divides the original surplus-and-shortage information into surplus-and-shortage information indicating that “there is a shortage of one worker at the section 5A, and there is a surplus of one worker at the section 5C” and surplus-and-shortage information indicating that “there is a shortage of one worker at the section 5B, and there is a surplus of one worker at the section 5D.” The candidate derivation unit 111 further divides the original surplus-and-shortage information into surplus-and-shortage information indicating that “there is a shortage of one worker at the section 5A, and there is a surplus of one worker at the section 5D” and surplus-and-shortage information indicating that “there is a shortage of one worker at the section 5B, and there is a surplus of one worker at the section 5C.”

On the basis of each piece of divisional surplus-and-shortage information, the candidate derivation unit 111 derives transportation methods. The derivation method already described is applicable to derivation of transportation methods with respect to the divisional surplus-and-shortage information. Subsequently, by combining the respective derived transportation methods, the candidate derivation unit 111 generates a candidate of a transportation method. A specific description is as follows.

Transportation methods (1) 5C→5A and (2) 5C→5B, 5B→5A are derived from the surplus-and-shortage information indicating that “there is a shortage of one worker at the section 5A, and there is a surplus of one worker at the section 5C.” Transportation methods (1) 5D→5B, (2) 5D→5A, 5A→5B, (3) 5D→5C, 5C→5B, and (4) 5D→5C, 5C→5A, 5A→5B are derived from the surplus-and-shortage information indicating that “there is a shortage of one worker at the section 5B, and there is a surplus of one worker at the section 5D.” In derivation of the aforementioned paths, an obviously inefficient path is excluded.

By combining the derived transportation methods, the following candidates (C1) to (C8) are acquired.
(C1) 5C→5A, 5D→5B
(C2) 5C→5A, 5D→5A, 5A→5B
(C3) 5C→5A, 5D→5C, 5C→5B
(C4) 5C→5A, 5D→5C, 5C→5A, 5A→5B
(C5) 5C→5B, 5B→5A, 5D→5B
(C6) 5C→5B, 5B→5A, 5D→5A, 5A→5B
(C7) 5C→5B, 5B→5A, 5D→5C, 5C→5B
(C8) 5C→5B, 5B→5A, 5D→5C, 5C→5A, 5A→5B

Note that the candidates (C6) and (C8) simultaneously include “5B→5A” and “5A→5B,” and execution of the transportation methods is pointless. Accordingly, the candidate derivation unit 111 may exclude the candidates (C6) and (C8) from the candidates.

Transportation methods (1) 5D→5A, (2) 5D→5B, 5B→5A, (3) 5D→5C, 5C→5A, and (4) 5D→5C, 5C→5B, 5B→5A are derived from the surplus-and-shortage information indicating that “there is a shortage of one worker at the section 5A, and there is a surplus of one worker at the section 5D.” A transportation method (1) 5C→5B is derived from the surplus-and-shortage information indicating that “there is a shortage of one worker at the section 5B, and there is a surplus of one worker at the section 5C.”

By combining the derived transportation methods, the following candidates (C9) to (C12) are acquired.
(C9) 5D→5A, 5C→5B
(C10) 5D→5B, 5B→5A, 5C→5B
(C11) 5D→5C, 5C→5A, 5C→5B
(C12) 5D→5C, 5C→5B, 5B→5A, 5C→5B

However, the candidate (C10) is equivalent to the candidate (C5), the candidate (C11) is equivalent to the candidate (C3), and the candidate (C12) is equivalent to the candidate (C7). Accordingly, the candidate derivation unit 111 may exclude the candidates (C10) to (C12) from the candidates. From the above, there are seven derived candidates, i.e., (C1) to (C5), (C7), and (C9).

### [4] Derived Candidate

The candidate derivation unit 111 does not necessarily derive every transportation method that may have the highest rating. In a particular case that the number of candidates is enormous, an upper limit may be provided for the number of transportation methods derived by the candidate derivation unit 111, in order to reduce a time required for processing by each unit. In other words, for example, the candidate derivation unit 111 may derive a predetermined number of transportation methods.

When the candidate derivation unit 111 derives every transportation method that may have the highest rating, the transportation planning device 11 is able to derive a transportation method with the highest rating. When a rating is an indicator of efficiency, the transportation planning device 11 will derive a most efficient transportation method.

When the candidate derivation unit 111 derives only a predetermined number of transportation methods, efficiency of an allocation change based on a candidate with the highest rating out of the derived candidates may not be best; however, the efficiency is expected to be good to some extent. The reason is that it can be said that at least one less than the predetermined number of candidates with a lower rating than that of the candidate exist. In other words, even in this case, the transportation planning device 11 can be sufficiently expected to provide an effect of acquiring a transportation method with a certain level of efficiency in a sufficiently short time for continuously controlling a work system in progress.

### [5] Path Derivation Method

As already described, the candidate derivation unit 111 may derive paths each of which connects a section with a surplus of workers (hereinafter referred to as a “surplus section”) to a section with a shortage of workers (hereinafter referred to as a “shortage section”) in derivation of candidates and derive a transportation method on the basis of the path. A detailed example of a method of derivation of the paths is described below.

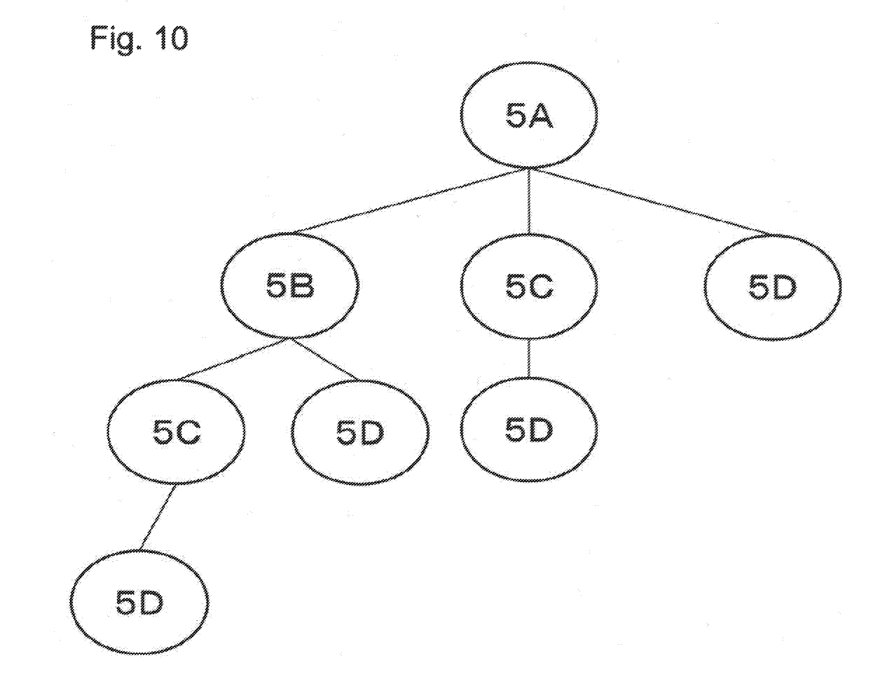

As an example, paths derived by the candidate derivation unit 111 can be represented by tree-structured data as illustrated in FIG. 10. The data illustrated in FIG. 10 have a tree structure in which a shortage section is the root node, every leaf node is a surplus section, and a nodes that are neither a shortage section nor a surplus section are nodes connecting the root node to a leaf node. The data illustrated in FIG. 10 represent four paths derived by the candidate derivation unit 111 in the example in the first case. For example, in the tree-structured data as illustrated in FIG. 10, a path from any leaf node to the root node represents a derived path. For example, by tracing a path from “5D” being the leftmost leaf node to “5A” being the root node, a path being “5D→5C→5B→5A” is specified. In other words, in such a tree structure, a parent node represents a next transportation destination, and a child node represents a transportation origin of a worker moving to a parent node. Paths starting from different leaf nodes are all different paths.

The candidate derivation unit 111 may derive every path excluding an obviously inefficient path. Such a derivation method is described below. While a path derivation method is exemplarily described below on the model of a procedure generating tree-structured data as illustrated in FIG. 10, the candidate derivation unit 111 may derive a path by another algorithm not generating tree-structured data but being under the same concept.

FIG. 11 is a flowchart illustrating an example of a procedure for generating the tree-structured data as illustrated in FIG. 10. The procedure described in the present disclosure is merely an example and may be changed as appropriate.

The candidate derivation unit 111 first specifies a surplus section and a shortage section (Step S111). For example, the surplus shortage and the shortage section can be specified from surplus-and-shortage information. On the basis of the example in the first case, the surplus section is the section 5D, and the shortage section is the section 5A.

Next, the candidate derivation unit 111 specifies a section with one or more movable workers (Step S112). In subsequent processing, a “section” that may become a node other than the root node is the section specified in the processing in this Step S112. In other words, the section specified here is a section that may be included in an extracted path.

Next, the candidate derivation unit 111 sets the shortage section specified in Step S111 as the root node (Step S113).

Then, the candidate derivation unit 111 generates a neighboring section of the shortage section, and the surplus section as child nodes of the root node (Step S114). This processing is processing of specifying a transportation origin of a worker moving toward the root node (shortage section). In this description, a “neighboring section of a section X” refers to a section closer than a surplus section for the section X, that is, a section a travel time from which to the section X is shorter than a travel time from the surplus section to the section X. On the basis of the example in the first case, the travel time from the section 5B to the shortage section 5A is shorter than the travel time from the surplus section 5D to the shortage section 5A. Accordingly, the section 5B is a neighboring section of the shortage section 5A. The section 5C is also a neighboring section of the shortage section 5A. Accordingly, in the example in the first case, the candidate derivation unit 111 generates the sections 5B and 5C which are neighboring sections of the shortage section and the section 5D which is the surplus section as child nodes of the root node. In other words, by the processing, workers at the section 5B, 5C, and 5D are specified to be candidates of a worker that should move to the section 5A.

Next, the candidate derivation unit 111 generates an empty exclusion list for each generated child node other than the surplus section (Step S115). An exclusion list is a list of identifiers of sections respectively associated with nodes other than the surplus section. The exclusion list is used in processing in Steps S118 to S120, to be described later. An exclusion list is a list of identifiers of sections that will not become child nodes of the section holding the exclusion list.

Next, the candidate derivation unit 111 determines whether every leaf node is the surplus section (Step S116). When every leaf node is the surplus section (YES in Step S116), the tree structure is completed (derivation of every path is completed), and therefore the candidate derivation unit 111 ends the generation processing of the tree structure. When there is a leaf node that is not the surplus section (NO in Step S116), the processing advances to Step S117. In other words, the candidate derivation unit 111 performs processing in and after Step S117 as long as there is a leaf node not being the surplus section. In the example in the first case, “5B” and “5C”, which are child nodes of the root node, are leaf nodes that are not surplus sections at this point in time.

In Step S117, the candidate derivation unit 111 selects a leaf node that is not the surplus section. When there are a plurality of leaf nodes that are not the surplus section, the candidate derivation unit 111 selects one leaf node out of the plurality of leaf nodes. For example, a selection method may be a method based on any algorithm, such as a selection method based on random numbers or a method of making a selection on the basis of a depth of the node and a travel time from the parent node. For example, the candidate derivation unit 111 may select a leaf node with the deepest depth and the longest travel time from the parent node, out of leaf nodes that are not the surplus section. It is presupposed as an example that the candidate derivation unit 111 selects “5C” which a child node of the root node.

Then, the candidate derivation unit 111 adds an identifier of a section closer to a section corresponding to the parent node than the selected node out of neighboring sections of the selected node, and an identifier of the selected node to an exclusion list of the selected node (Step S118). In the example described here, a neighboring section of the section “5C” indicated by the selected node is “5B,” and the section 5B is closer to the parent node (section 5A) than the section 5C. Accordingly, the candidate derivation unit 111 adds an identifier of the section 5B to the exclusion list of the selected node. Further, the candidate derivation unit 111 also adds an identifier of the section (section 5C) indicated by the selected node to the exclusion list of the selected node.

Then, the candidate derivation unit 111 generates a neighboring section (when existent) of the selected node an identifier of which is not included in the exclusion list of the selected node, and the surplus section as child nodes of the selected node (Step S119). In the example described here, a neighboring section of the selected node is the section 5B; however, the exclusion list of the selected node describes the identifiers of the sections 5B and 5C, and therefore the section 5B is not generated as a child node. The candidate derivation unit 111 generates only the surplus section 5D as a child node of the selected node.

Then, the candidate derivation unit 111 generates, in each generated child node other than the surplus section, an exclusion list with the same content as that of the exclusion list of the selected node (Step S120). However, when there is no generated child node other than the surplus section, this processing may be omitted.

Subsequently, the processing returns to Step S116.

Thus, the candidate derivation unit 111 repeats the processing from Step S116 to Step S120 until every leaf node becomes the surplus section.

Consequently, the tree-structured data as illustrated in FIG. 10 are generated. The data structure represents paths derived by the candidate derivation unit 111. The paths represented by the tree-structured data do not include an obviously inefficient path (such as “5D→5B→5C→5A” in the first case). The reason is that, out of neighboring sections of the selected node, an identifier of a section closer to a section being the parent node than the selected node is added to the exclusion list in Step S118. By the processing, when a travel time from a second section to a first section is not longer than a travel time from a third section to the first section, a path moving from the second section to the first section through the third section is not derived. The reason that such a path is obviously inefficient is as already described in “Derivation of Candidate.”

Conversely, every path represented by the tree-structured data is a non-obviously-inefficient path. In other words, a path represented by the tree-structured data is a path characterized in such a way that a travel time from a section immediately preceding an arbitrary section included in the path is always shorter than a travel time for directly moving from a section preceding the immediately preceding section to the arbitrary section.

By not deriving an obviously inefficient path, derived paths and candidates can be reduced, and therefore a processing time is shortened.

In the processing illustrated in FIG. 11, by the determination in Step S116, the candidate derivation unit 111 is able to derive every non-obviously-inefficient path. As a modified example, the candidate derivation unit 111 may derive only a predetermined number of paths. Specifically, the determination in Step S116 may be changed to a determination being “a predetermined number of leaf nodes are the surplus section?” Even in this case, by not deriving an obviously inefficient path, a calculation resource can be allocated to a candidate expected to have a higher rating.

By path searching as described above, the candidate derivation unit 111 can derive a candidate that may have the highest rating while eliminating useless processing. Even when the candidate derivation unit 111 does not derive every path, a candidate expected to have a higher rating can be derived.

### [6] Modified Example

The transportation planning device 11 may include a transportation method reception unit that receives a transportation method. For example, the transportation method reception unit receives an input of a transportation method from a supervisor of a work environment. For example, an input transportation method is a transportation method planned by the supervisor of the work environment.

In this case, the calculation unit 112 calculates a rating of a received transportation method. When the transportation method reception unit receives a plurality of transportation methods, ratings of the plurality of transportation methods are calculated. The output unit 113 outputs a rating of a received transportation method. When ratings of a plurality of transportation methods are calculated, the output unit 113 may output each rating or may output information specifying a transportation method with the highest rating.

With such a configuration, a person who has input a transportation method to the transportation planning device 11 can learn a rating of the input transportation method. When inputting a plurality of transportation methods, the person can learn a transportation method with the highest rating among the methods.

The candidate derivation unit 111 may derive one or more other transportation methods providing a transportation result similar to that by a received transportation method. For example, when a received transportation method is a transportation method of one worker moving from the section 5D to the section 5B, another transportation method of decreasing the number of workers at the section 5D by one and increasing the number of workers at the section 5B by one may be derived. Then, the calculation unit 112 may calculate a rating of the transportation method derived by the candidate derivation unit 111. When a rating of the derived transportation method is higher than a rating of the received transportation method, the output unit 113 may output information indicating the derived transportation method.

With such a configuration, a person who has input a transportation method to the transportation planning device 11 can learn a transportation method with a higher rating, that is, more efficient, than the input transportation method.

When every one of ratings of a plurality of transportation methods derived by the candidate derivation unit 111 is lower than or equal to a rating of a received transportation method, the output unit 113 may output the number of the derived transportation methods and information indicating that the ratings of the transportation methods do not exceed the rating of the received transportation method. The output unit 113 may output information indicating a deviation value of the rating of the received transportation method. In this case, the person who has input the transportation method to the transportation planning device 11 can learn that the input transportation method is a transportation method with a certain level of efficiency.

### Second Case

In the example presented in the first case, a candidate with the highest work efficiency value may be reworded as a candidate with a shortest time required for resolving surplus and shortage. However, when work efficiency in the presence of a shortage of workers varies by sections, a candidate with the highest work efficiency value is not necessarily identical to a candidate with a shortest time required for resolving surplus and shortage.

A second case presupposes that work efficiency varies by sections. A configuration of a work environment E2 related to the second case may be identical to the configuration of the work environment E1. Specifically, conditions such as operation details and a workflow may be identical to the conditions in the first case. However, travel time information and efficiency information in the second case differ from the travel time information and the efficiency information in the first case.

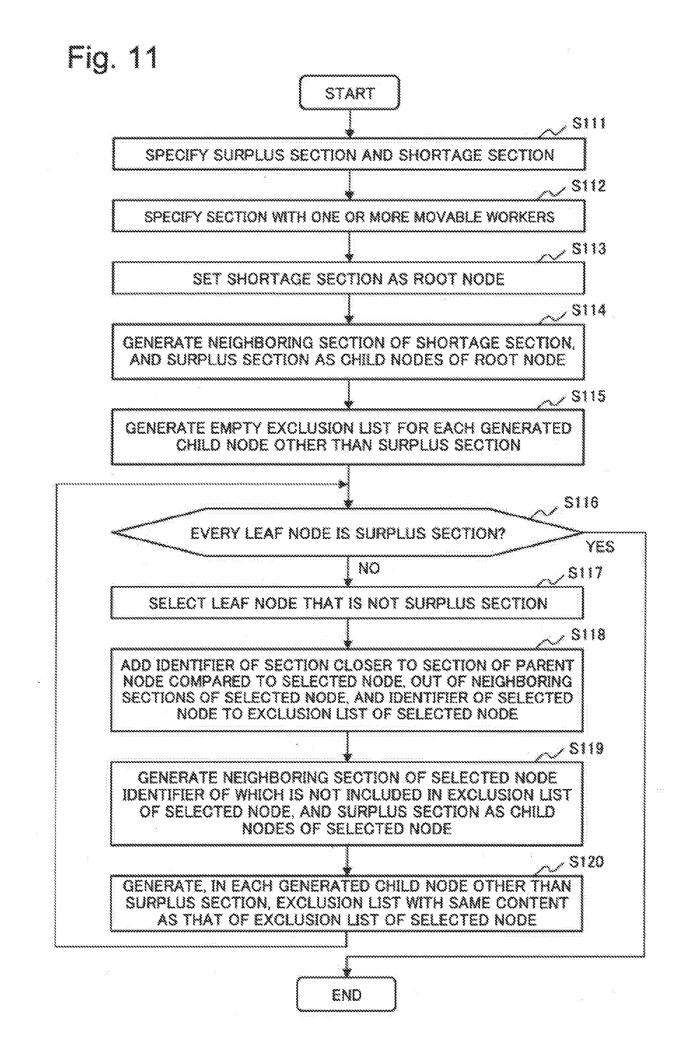

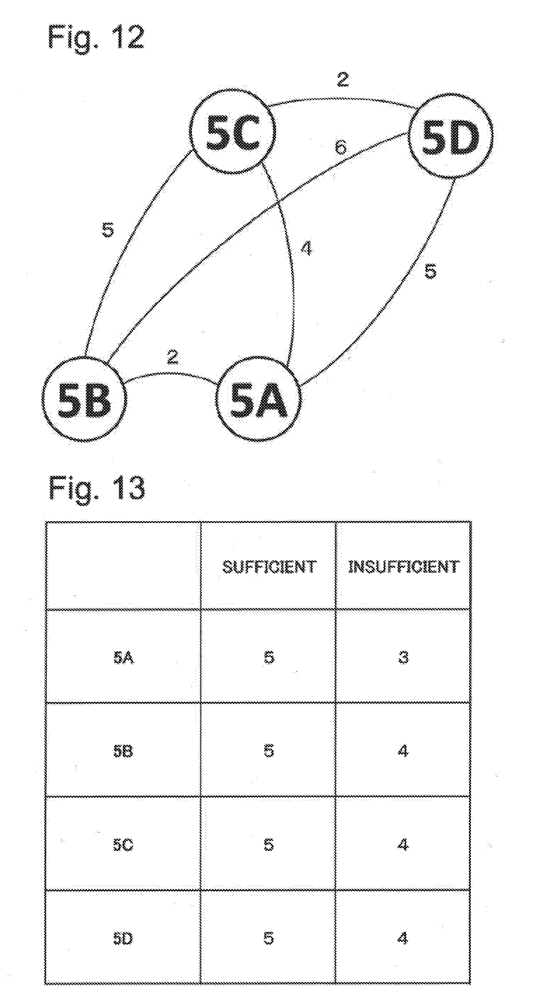

FIG. 12 is a schematic diagram illustrating travel times between respective sections in the second case. For example, according to FIG. 12, a travel time between the section 5D and the section 5B is 6 minutes, and a travel time between the section 5C and the section 5A is 4 minutes.

FIG. 13 is a diagram illustrating efficiency information at each section in the second case. In the second case, while work efficiency when there is a shortage of workers at the section 5A is “3,” work efficiency when there is a shortage of workers at each of the sections 5B, 5C, and 5D is “4,” as illustrated in FIG. 13.

An example of processing by the transportation planning device 11 in an example as described above is described below.

First, the condition acquisition unit 110 acquires information required for transportation planning. Specifically, in the second case, the condition acquisition unit 110 acquires the flow information illustrated in FIG. 3, the surplus-and-shortage information illustrated in FIG. 7, the travel time information illustrated in FIG. 12, and the efficiency information illustrated in FIG. 13.

The candidate derivation unit 111 derives candidates of a transportation method improving efficiency of an entire process (that is, resolving surplus and shortage) on the basis of acquired information. For example, a derivation method of candidates may be similar to the derivation method described in the first case. In accordance with the derivation method described in the first case, the candidate derivation unit 111 derives the following four candidates.
Candidate (1): One worker moves from the section 5D to the section 5A.
Candidate (2): One worker moves from the section 5D to the section 5B, and one worker moves from the section 5B to the section 5A.
Candidate (3): One worker moves from the section 5D to the section 5C, and one worker moves from the section 5C to the section 5A.
Candidate (4): One worker moves from each of the sections 5D, 5C, and 5B to the sections 5C, 5B, and 5A, respectively.

When candidates are derived, the calculation unit 112 calculates a rating for each candidate.

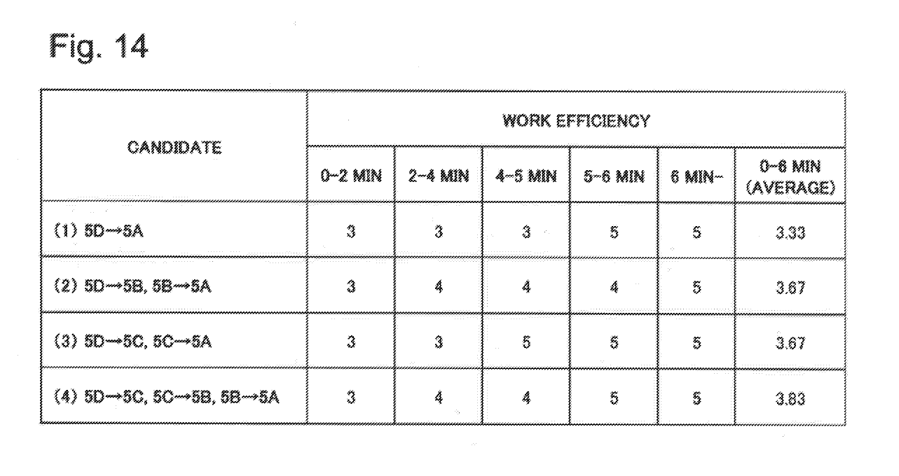

FIG. 14 is a diagram illustrating an example of calculation performed by the calculation unit 112. The leftmost columns in the table in FIG. 14 indicate the four candidates derived by the candidate derivation unit 111. The calculation unit 112 derives a chronological change in work efficiency for each candidate, as indicated in the “WORK EFFICIENCY” columns in the table in FIG. 14.

In the case of the candidate (1), work at the section 5A is a bottleneck until one worker reaches the section 5A from the section 5D. Accordingly, work efficiency until 5 minutes after the start of the transportation is “3,” and the work efficiency becomes “5” after 5 minutes.

In the case of the candidate (2), the work efficiency at the section 5A is improved by a transportation of a worker from the section 5B after 2 minutes. However, there is a shortage of one worker at the section 5B, and therefore the work efficiency remains at “4” between 2 minutes after the start and 6 minutes after the start. One worker from the section 5D reaches the section 5B 6 minutes after the start of the transportation, and therefore the work efficiency becomes “5” after 6 minutes.

In the case of the candidate (3), the work efficiency at the section 5A is improved by a transportation of a worker from the section 5C after 4 minutes. A transportation of a worker from the section 5D to the section 5C is already completed at this point in time, and therefore the work efficiency becomes “5” after 4 minutes.

In the case of the candidate (4), the work efficiency at the section 5A is improved by a transportation of a worker from the section 5B after 2 minutes. However, there is a shortage of one worker at the section 5B, and therefore the work efficiency remains at “4” between 2 minutes after the start and 5 minutes after the start. One worker from the section 5C reaches the section 5B after 5 minutes, and therefore a state of the section 5B being a bottleneck is resolved. A transportation of a worker from the section 5D to the section 5C is already completed at this point in time, and therefore the work efficiency becomes “5” after 5 minutes.

From the above, efficiency of the entire process becomes optimum efficiency after 6 minutes in every candidate. Accordingly, for example, the calculation unit 112 determines an average of work efficiency from a start of a transportation to 6 minutes after the start. As indicated in the table in FIG. 14, averages of work efficiency in the candidates (1) to (4) are 3.33, 3.67, 3.67, and 3.83, respectively. Accordingly, it is understood that the most efficient transportation method is the transportation method by the candidate (4).

The output unit 113 outputs information based on a calculate result by the calculation unit 112, similarly to the first case. For example, the output unit 113 may extract the transportation method by the candidate (4) which is the most efficient transportation method as a “transportation method to be executed.”

Consequently, workers in the work environment E2 can perform moves for resolving surplus and shortage by the most efficient transportation method.

Note that the candidate (4) specified as the most efficient transportation method in the second case is not a transportation method resolving surplus and shortage earliest nor a transportation method with the minimum total sum of travel times of workers. A transportation method resolving surplus and shortage earliest in the second case is the candidate (3). Thus, a most efficient transportation method and a transportation method resolving surplus and shortage earliest may not necessarily match. Even in such a case, the transportation planning device 11 can derive a most efficient transportation method.

### Supplement

The workflow illustrated in FIG. 3 may include parallel processes. Parallel processes refer to a plurality of processes without interdependence. For example, when both of a process immediately after a work process at the section 5A and a process immediately after a work process at the section 5B are a work process at the section 5C, the work process at the section 5A and the work process at the section 5B are parallel processes. In this case, even when work efficiency at the section 5A is “5,” work efficiency at the section 5C becomes “4” when work efficiency at the section 5B is “4.” In other words, work efficiency of a downstream process of parallel processes depends on work efficiency of a process with the lowest work efficiency in the parallel processes. The transportation planning device 11 can perform processing similarly to the processing described above even on the basis of flow work information including a process having such a rule.

### Third Case

The cases described above set a premise that a change in work efficiency at each section is immediately reflected in a next process. A third case presupposes that a change in work efficiency at each section is reflected in a next process after a predetermined time.

A configuration of a work environment E3 related to the third case may be identical to the configuration of the work environment E1. Specifically, conditions such as a workflow and efficiency information in the third case may be identical to the conditions in the first case.

A condition of a travel time between sections in the third case differs from the condition in the first case. Further, the third case differs from the first case in that information about a time until a downstream process is affected when work efficiency changes is included in a condition of transportation planning.

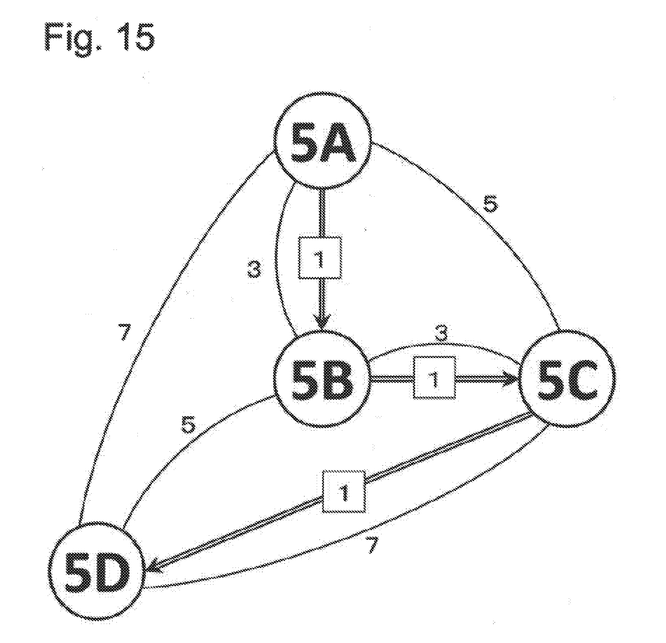

FIG. 15 is a schematic diagram illustrating travel times between respective sections and a time until a change in work efficiency of a process in each section affects a next process. In FIG. 15, a number attached to a curve connecting sections indicates a time required for a transportation between the sections (the unit of which is “minute”). Further, a number superposed on an arrow from a section toward another section indicates a time until a change in work efficiency at a section being a start point of the arrow affects work efficiency at a section being an end point of the arrow. For example, according to FIG. 15, a time until a change in work efficiency at the section 5A affects work efficiency at the section 5B is 1 minute.

It is presupposed here that there is a shortage of one worker at the section 5A, and there is a surplus of one worker at the section 5D. A specific procedure of performing transportation planning by the transportation planning device 11 for resolving surplus and shortage in this case is described here.

The condition acquisition unit 110 acquires information required for transportation planning.

The candidate derivation unit 111 derives candidates of a transportation method on the basis of acquired information. A derivation method of a transportation method may be similar to the method described in the first case. The candidate derivation unit 111 derives four transportation methods (identical to the candidates in the first case) as candidates of the transportation method.

The calculation unit 112 calculates a rating of each derived candidate. For example, a rating is an average of work efficiency in 10 minutes from a start of a transportation. At this time, the calculation unit 112 uses a time until the work efficiency affects a next process in the calculation. Specifically, the calculation unit 112 performs calculation as described below.

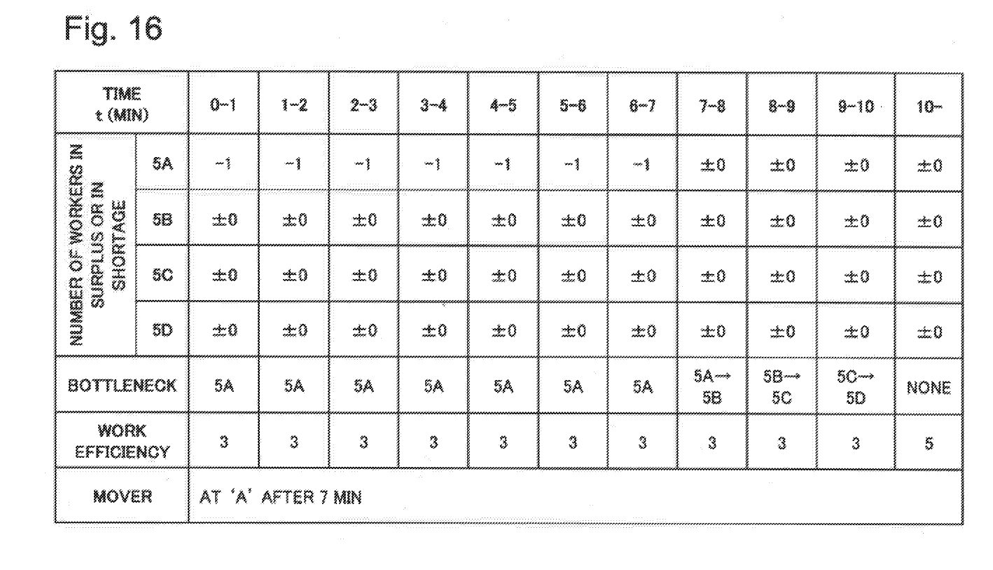

A method of calculation by the calculation unit 112 is hereinafter described with the candidate (1) as an example. FIG. 16 is a diagram illustrating a concept of calculation of efficiency with respect to the candidate (1). For example, the calculation unit 112 calculates production efficiency per minute as illustrated in FIG. 16.

A number in the top column indicates an elapsed time from a start of a transportation. For convenience of description, “t” is hereinafter defined as a variable denoting an elapsed time. In order to calculate production efficiency per minute, the calculation unit 112 specifies a “NUMBER OF WORKERS IN SURPLUS OR IN SHORTAGE” and a “BOTTLENECK” per minute in each area. As a reference, information about a moving worker is indicated in the bottom column of the table in FIG. 16.

Referring to the table in FIG. 16, an outline of calculation is described. When the candidate (1) is employed, one worker moves from the section 5D to the section 5A. Since the moving worker reaches the section 5A after 7 minutes, a surplus or shortage of workers at the section 5A stays at “−1” and does not change from the start of the transportation until 7 minutes after the start (t=0 to 7). During this period, a bottleneck is the section 5A, and therefore work efficiency is “3.” The surplus or shortage of workers at the section 5A changes to “±0” after 7 minutes. However, it takes 1 minute for the work efficiency improved at the section 5A to be reflected in the section 5B, and therefore work efficiency in the entire process (work efficiency at the section 5D, so to speak) does not change. The “BOTTLENECK” column indicates “5A→5B” meaning that although the work efficiency at the section 5A is improved, the work efficiency at the section 5A is not yet reflected in the section 5B. In a period from t=7 to t=9, the transportation of the worker is completed; however, the change in the work efficiency does not yet affect the section 5D, and therefore the work efficiency remains at “3.” Then, finally at t=10, the change in the work efficiency at the section 5A is reflected in the section 5D, and the bottleneck is completely resolved. Specifically, a cell corresponding to “BOTTLENECK” in the column t=“10-” indicates “NONE,” and the work efficiency becomes “5.”

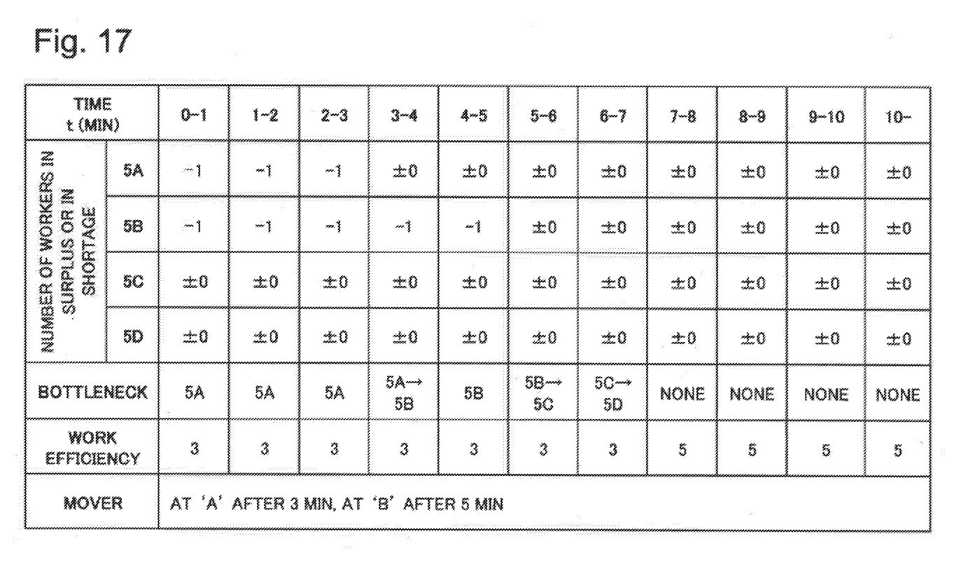

FIG. 17 is a diagram illustrating a concept of calculation of efficiency with respect to the candidate (2). When the candidate (2) is employed, one worker moves from the section 5B to the section 5A taking 3 minutes, and one worker moves from the section 5D to the section 5B taking 5 minutes. Accordingly, there is a shortage of one worker at each of the sections 5A and 5B from the start of the moves until 3 minutes after the start, and a bottleneck is the section 5A. The number of workers at the section 5A is filled after 3 minutes. Accordingly, the bottleneck becomes “5A→5B.” There is still a shortage of a worker at the section 5B in a period of t=4 to 5, and therefore the section 5B becomes a bottleneck. The transportation of the worker from the section 5D to the section 5B completes at t=5, and the section 5B is no longer a bottleneck. Subsequently, the change in work efficiency at the section 5B is reflected in the section 5D taking 2 minutes, and the bottleneck is completely resolved at t=7. In other words, the work efficiency becomes “5” from t=7.

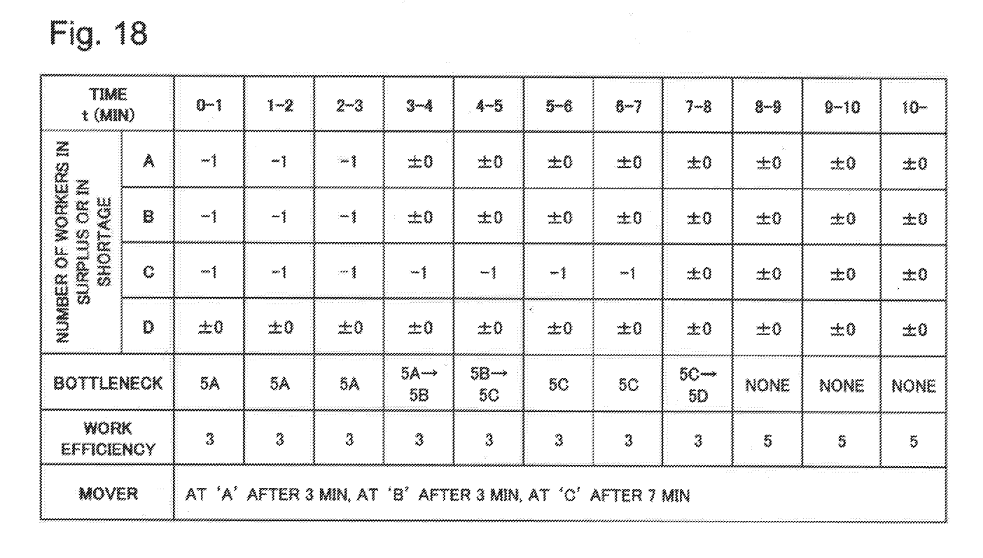

FIG. 18 is a diagram illustrating a concept of calculation of efficiency with respect to the candidate (4). When the candidate (4) is employed, since a transportation from the section 5D to the section 5C takes 7 minutes, the section 5C is a bottleneck until t=6 even when work efficiency at the sections 5A and 5B is improved. Work efficiency at the section 5C is improved at t=7, the improved work efficiency is reflected in the section 5D at t=8. Accordingly, the work efficiency becomes “5” from t=8.

Similarly, in the case of the candidate (3), work efficiency is “3” until t=7 and becomes “5” from t=8.

According to the calculations described above, a time required for reaching an intended allocation is 10 minutes at the longest. For example, the calculation unit 112 calculates an average of efficiency in 10 minutes from a start of a transportation as a rating of each candidate. Then, ratings of the candidates (1) to (4) are calculated to be 3.0, 3.6, 3.4, and 3.4, respectively.

Accordingly, it is understood that the most efficient transportation method in the third case is the transportation method by the candidate (2).

The output unit 113 outputs information based on a rating, similarly to the first case. For example, the output unit 113 outputs the transportation method by the candidate (2).

An output order of a set (hereinafter referred to as a “transportation unit”) of a transportation origin section, a transportation destination section, and the number of moving workers, which is included in an output transportation method may be arranged as appropriate. For example, the output unit 113 may preferentially output a transportation unit urgently required for improvement of work efficiency sooner, out of a plurality of transportation units. In the third case, even when the transportation from the section 5B to the section 5A is delayed by 1 minute, the overall work efficiency is not affected; however, delay in the transportation from the section 5D to the section 5B directly affects the overall work efficiency. Accordingly, the output unit 113 may output a transportation unit representing the transportation from the section 5D to the section 5B in preference to a transportation unit representing the transportation from the section 5B to the section 5A.

Consequently, in a particular case that a lag occurs between respective transportation instructions, such as a case that transportation instructions are not given simultaneously, an urgently required transportation unit is immediately executed, and expected efficiency can be achieved. When a supervisor gives transportation instructions, the supervisor does not need to consider an order of the transportation instructions, and therefore a load on the supervisor is lightened.

Furthermore, the output unit 113 may output an urgently required transportation unit in a mode different from an output mode of other transportation units. Examples of the different mode include changing a color and a size of a display of the transportation unit and adding an announcement by sound; however, the mode is not limited to the above. Such a configuration facilitates a worker or a supervisor to recognize an urgently required transportation unit. Consequently, for example, a worker can understand that a transportation of the worker is an urgently required action. Accordingly, a more efficient transportation is likely to be achieved.

By the processing as described above, the transportation planning device 11 can provide a transportation method that optimizes efficiency of an entire process even when it takes time for a change in work efficiency in an upstream process to affect work efficiency in a downstream process.

A most efficient transportation method in the third case may vary depending on a condition of a time required for reflecting a change in work efficiency. For example, assuming that a time required for reflecting a change in work efficiency from the section 5B to the section 5C is 4 minutes in the example illustrated in FIG. 15, the candidate (4) is derived as the most efficient transportation method.

Thus, the transportation planning device 11 is expected to be able to derive an optimum solution, that is, a most efficient transportation method, for a more complicated case in a sufficiently short time.

### Fourth Case

The cases described above are cases in which upstream production efficiency affects downstream production efficiency. A fourth case presupposes that upstream production efficiency does not affect downstream production efficiency. In the fourth case, work at each section is performed regardless of work efficiency at another section. It is presupposed that an upstream/downstream relation may exist in work at each section but upstream production efficiency does not affect downstream production efficiency. In other words, it is presupposed that work targets inexhaustibly exist at each section, and work efficiency is not affected by an amount of flow from an upper stream. For example, a case that a sufficient number of unprocessed containers 4 exist at each section in the work environment E1 applies to this case.

A work environment E4 is hereinafter presupposed as an example of a work environment applied to the fourth case. It is presupposed that the work environment E4 includes four sections 5A, 5B, 5C, and 5D, similarly to the work environment E1. It is presupposed that travel times between the sections are identical to the travel times in the first case.

Workers are allocated at respective sections and perform a production operation. The production operation may be, for example, assembly of articles, or forming and processing of articles. An operation at each section may be identical or different. A unified indicator is defined as an indicator of an outcome of the production operation. As an example, a production amount, that is, the number of products on which the production operation is accomplished, per unit time is defined as an indicator of an outcome of the operation at each section.

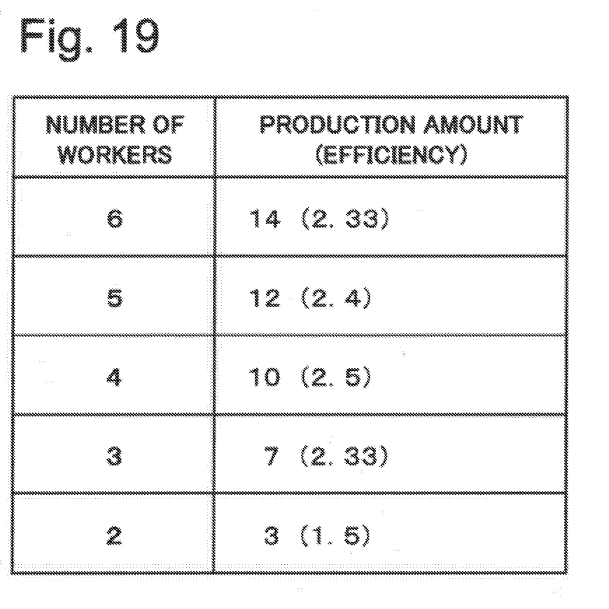

The fourth case presupposes that work efficiency more minutely varies in accordance with the number of workers. A table in FIG. 19 illustrates a relation between the number of workers, and a production amount and production efficiency per unit time (such as one minute) at each section in the fourth case. As illustrated in FIG. 19, generally, a production amount is not necessarily proportional to the number of workers. The most suitable number of workers, that is, the number of workers that provides the highest work efficiency exists for work. Referring to the example in the table in FIG. 19, for example, when the number of workers is six, a production amount is 14 and efficiency (a production amount per worker) is 2.33, and when the number of workers is five, the production amount is 12 and the efficiency is 2.4. However, when the number of workers is four, the production amount is 10 and the efficiency is 2.5, and this case is more efficient than the case of the number of workers being five or more. When the number of workers is three or less, the efficiency is 2.33 (in the case of three) or 1.5 (in the case of two), and the efficiency decreases. Accordingly, this case presupposes that an optimum number of workers performing work at each section is four.

Efficiency information as described above may be set on the basis of actual production status. For example, the condition acquisition unit 110 may generate efficiency information on the basis of a work result log acquired by a supervisory system supervising the work environment E4 and information about a work result totaled and calculated on the basis of a work supervision log. With such a configuration, the condition acquisition unit 110 can more accurately calculate an effect of a change in the number of workers on work efficiency on the basis of a work result at each section. Accordingly, transportation planning can be performed more accurately.

It is presupposed here that the number of workers at the section 5A is two, the number of workers at the section 5B is four, the number of workers at the section 5C is four, and the number of workers at the section 5D is six. Assuming that an allocation of four workers at each section is an intended allocation, currently there is a shortage of two workers at the section 5A, and there is a surplus of two workers at the section 5D.

In this case, the transportation planning device 11 plans a method of workers moving in such a way that the number of workers at each section becomes four.

The condition acquisition unit 110 acquires various types of information described above.

The candidate derivation unit 111 derives a candidate resolving surplus and shortage on the basis of acquired information.

The candidate derivation unit 111 first specifies the number of movable workers. In a case that a production amount varies in accordance with the number of workers, such as the fourth case, the number of movable workers at each section is calculated, for example, as follows.
The number of movable workers is an upper limit of the number of workers who can leave a section, the number satisfying a condition as described below. Condition: A difference at the section between efficiency in a case that the number of workers leave the section and efficiency in a case that an intended number of workers exist is less than a difference at a shortage section between current efficiency and efficiency in the case that the intended number of workers exist.

In the case of the fourth case, a difference at the shortage section 5A between current efficiency and efficiency in a case that an intended number of workers exist is 2.5−1.5=1. Accordingly, workers at each section can leave a section as long as efficiency is not less than or equal to “1.5” which is a value less than “2.5” by “1”. The value “2.5” is the efficiency in the case that the intended number of workers exist at each section. Specifically, numbers of movable workers at the sections 5B, 5C, and 5D are 1, 1, and 3, respectively.

When there are a plurality of shortage sections, a “difference between current efficiency and efficiency in the case that the intended number of workers exist” in the condition described above may be read as the total sum of differences at the respective shortage sections between current efficiency and efficiency in the case that the intended number of workers exist.

Then, the candidate derivation unit 111 derives candidates of a transportation method.

For example, on the basis of the path derivation method described in the section “When Surplus or Shortage of Two or More Workers Exists” in the present disclosure, the following candidates are finally derived.
Candidate (C1): 5D→5A, 5D→5A
Candidate (C2): 5D→5A, 5D→5B, 5B→5A
Candidate (C3): 5D→5A, 5D→5C, 5C→5A
Candidate (C4): 5D→5A, 5D→5C, 5C→5B, 5B→5A
Candidate (C5): 5D→5B, 5D→5B, 5B→5A, 5B→5A
Candidate (C6): 5D→5B, 5B→5A, 5D→5C, 5C→5A
Candidate (C7): 5D→5B, 5B→5A, 5D→5C, 5C→5B, 5B→5A
Candidate (C8): 5D→5C, 5D→5C, 5C→5A, 5C→5A
Candidate (C9): 5D→5C, 5C→5A, 5D→5C, 5C→5B, 5B→5A
Candidate (C10): 5D→5C, 5D→5C, 5C→5B, 5C→5B, 5B→5A, 5B→5A

Out of the candidates, the candidates (C5) and (C7) to (C10) do not satisfy the condition that the number of workers moving from a section does not exceed the number of movable workers at the section. Accordingly, these candidates may be excluded from the candidates.

The calculation unit 112 calculates a rating for each derived candidate. In the fourth case, for example, the calculation unit 112 calculates, as a rating, a total production amount in 7 minutes from a start of a transportation when the candidate is executed.

The reason for a target time for calculation of a total production amount being 7 minutes is that a time until the number of workers become optimized is 7 minutes at the longest. In other words, 7 minutes is a sufficient time for comparison of the candidates. However, the calculation unit 112 may calculate a total production amount in a time longer than or equal to 7 minutes. The calculation unit 112 may calculate production efficiency in 7 minutes.

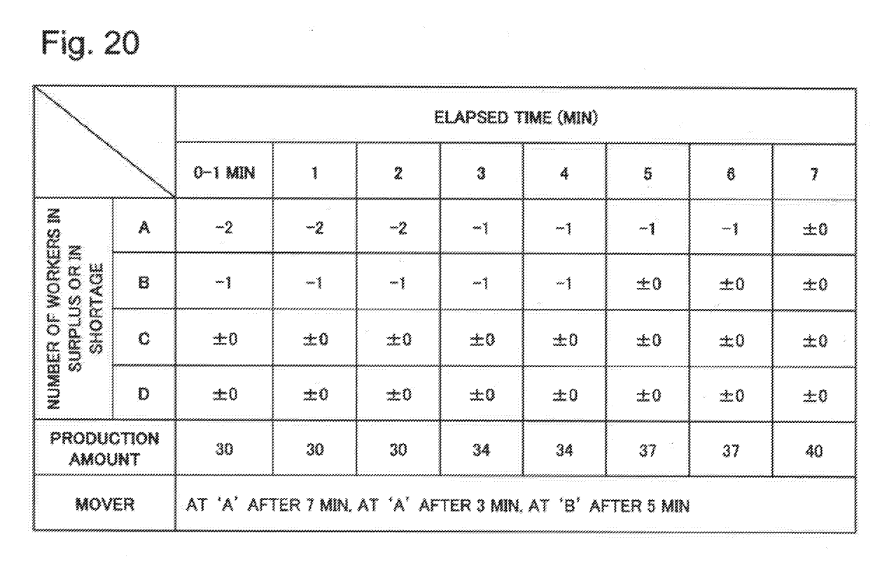

An example of calculation processing performed by the calculation unit 112 is hereinafter described with the candidate (C2) as an example. FIG. 20 is a diagram illustrating a concept of the calculation processing performed by the calculation unit 112.

The candidate (C2) is a transportation method of one worker at the section 5D moving to the section 5A and another worker moving to the section 5B, and a worker at the section 5B moving to the section 5A. When the candidate (C2) is employed, a chronological change in a production amount becomes as follows.
Until 3 minutes after the start of the transportation of workers, a production amount at the section 5A is “3,” a production amount at the section 5B is “7,” a production amount at the section 5C is “10,” and a production amount at the section 5D is “10.” Accordingly, a production amount is “30” per minute.
Since one worker reaches the section 5A after 3 minutes, the production amount at the section 5A becomes “7” from 3 minutes after the start to 5 minutes after the start, and the production amount becomes “34” per minute.
Since one worker reaches the section 5B after 5 minutes, the production amount at the section 5B becomes “10” from 5 minutes after the start to 7 minutes after the start, and the production amount becomes “37” per minute.
Since one worker reaches the section 5A after 7 minutes, the production amount becomes an optimum value of “40.”

Accordingly, a total production amount in 7 minutes in the case of the candidate (C2) becomes 30×3+34×2+37×2=232. Further, production efficiency is 33.1.

The calculation unit 112 may similarly calculate ratings of other candidates.

When a production amount minutely fluctuates or continuously changes, the calculation unit 112 may calculate an integral value of the production amount from 0 minutes to 7 minutes as a rating.

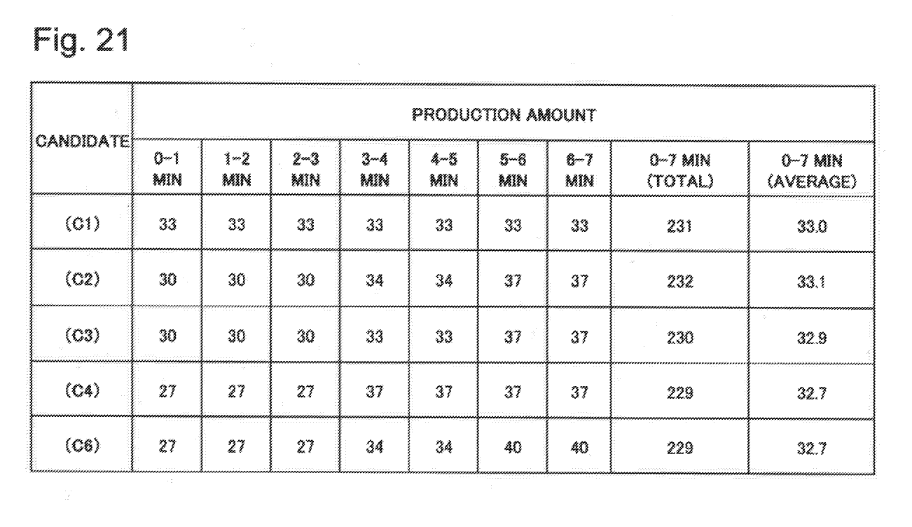

FIG. 21 is a diagram illustrating a table summarizing a chronological change in production amounts of the respective candidates (C1) to (C4) and (C6) and calculation results of total production amounts and average production amounts. A column “0-7 MIN (TOTAL)” describes a total production amount related to each candidate.

The output unit 113 outputs information based on a calculated result by the calculation unit 112. For example, the output unit 113 may output information specifying a candidate with the highest rating (such as a value of a total production amount). A content and a method of output, and the like may be similar to the content and the method described in the first case.

According to FIG. 21, a candidate with the highest rating is the candidate (C2). By outputting a candidate with the highest rating by the output unit 113, a worker can execute the transportation method. In other words, the worker can move in such a way as to provide an intended allocation, by a transportation method maximizing efficiency of an entire work environment.

When there are a plurality of candidates with the highest rating, the output unit 113 may select one of the candidates as a “transportation method to be executed.” The selection may be based on a method of random selection or may be based on a preset item. For example, the output unit 113 may select a candidate with a minimum (or maximum) total sum of travel times of movers, out of transportation candidates with a best production efficiency. When a candidate with a small total sum of travel times of movers is employed, a cost involved in moves (such as power consumption of a conveyance) can be suppressed. When a candidate with a large total sum of travel times of movers is employed, a time given to each worker other than a time for a production operation can be increased. In particular, the fourth case presupposes that every non-moving worker works at all times, and therefore it may be useful for a worker to be given a longer travel time.

In the fourth case, the transportation planning device 11 can provide a transportation method with a best efficiency.

By determining the number of movable workers at each of the sections by the candidate derivation unit 111, candidates can be narrowed down. Consequently, an amount of calculation by the calculation unit 112 can be reduced, and the transportation planning device 11 can more rapidly derive an optimum transportation method.

### Supplement

Efficiency information may vary according to sections. Assuming in the fourth case that efficiency in a case of the number of workers at the section 5B being three is “5,” a candidate extracted as the most efficient transportation method is the candidate (C1). Furthermore, assuming that efficiency at each section in a case of the number of workers being two is “2,” respectively, a candidate extracted as the most efficient transportation method is the candidate (C3). Thus, an optimum transportation method may change due to a change of a condition.

### Second Example Embodiment

A second example embodiment is hereinafter described. A transportation planning device 12 according to the second example embodiment is assumed to be applied to an environment different from that in the first example embodiment. For example, the transportation planning device 12 may perform planning of a transportation method of a person or a thing maximizing an effect and a benefit generated by a transportation of the person or the thing in a system set with measures of the effect and the benefit.

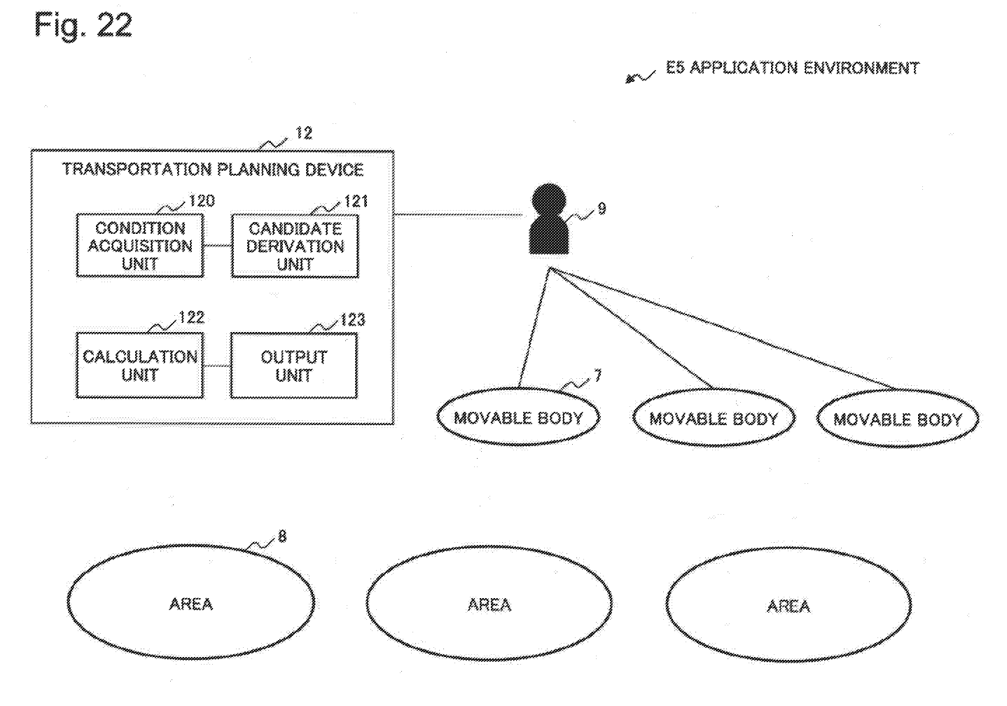

FIG. 22 is a schematic diagram illustrating a configuration of an application environment E5 which is an example of an environment to which the transportation planning device 12 according to the second example embodiment is applied. The application environment E5 includes the transportation planning device 12, a user 9 using the transportation planning device 12, movable bodies 7, and areas 8.

In the application environment E5, the transportation planning device 12 devises a transportation method of each movable body 7 moving to an area 8.

A movable body 7 provides a specific benefit for the application environment E5 by moving to an area 8.

The user 9 inputs information used for transportation planning to the transportation planning device 12. The transportation planning device 12 outputs a result of transportation planning. The user 9 gives a transportation instruction to a plurality of movable bodies 7 on the basis of a result output by the transportation planning device 12. A transportation instruction is an instruction including information indicating an area 8 out of a plurality of predetermined areas 8 to which a movable body 7 should move.

The transportation planning device 12 includes a condition acquisition unit 120, a candidate derivation unit 121, a calculation unit 122, and an output unit 123.

The condition acquisition unit 120 acquires information for devising a transportation plan, that is, a condition.

The candidate derivation unit 121 derives a candidate of a transportation method of a movable body 7 on the basis of information acquired by the condition acquisition unit 120.

The calculation unit 122 calculates a rating of a candidate derived by the candidate derivation unit 121 on the basis of a chronological change in a benefit generated by an allocation change based on the candidate.

The output unit 123 outputs information based on a rating.

A specific example of processing by units in the transportation planning device 11 is described below with a specific case that may become a target of transportation planning by the transportation planning device 12 as an example.

### Fifth Case

It is presupposed that there are three stricken places suffering a disaster and three rescue squads capable of coping with the disaster. Under this situation, it is presupposed that the three rescue squads are to move to separate stricken places, respectively, and cope with the disaster. In this case, a rescue squad corresponds to a movable body 7, and a stricken place corresponds to an area 8.

In the fifth case, a time required for a rescue squad to move to each location varies according to the rescue squad. For example, it may be assumed that the rescue squads are at separate bases. It may be assumed that transportation means used by the rescue squads are different.

For convenience of explanation, the description herein presupposes that two of the three squads have the same travel time to each stricken place. Specifically, it is presupposed that two of the three squads are at the same base and use the same transportation means. It is presupposed that one of the three squads is at a separate base.

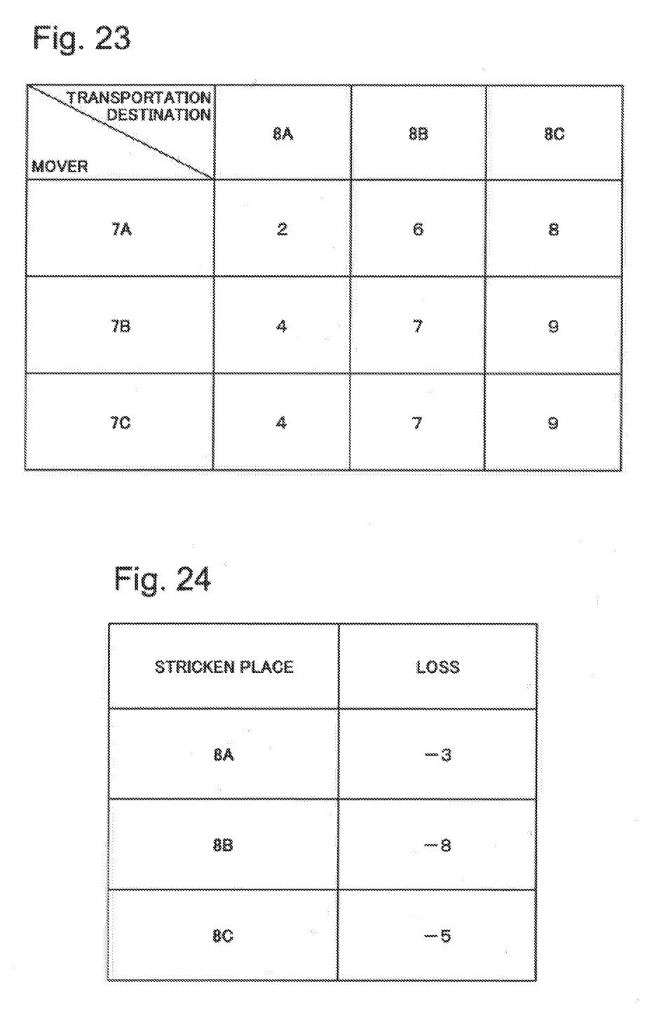

FIG. 23 is a diagram illustrating a table indicating a travel time of each rescue squad to each stricken place in the fifth case. Identifiers of three stricken places being “8A,” “8B,” and “8C” are listed in one direction of the table as “TRANSPORTATION DESTINATION.” Identifiers of the respective rescue squads being “7A,” “7B,” and “7C” are listed in another direction of the table as “MOVER.” A cell related to each mover and each transportation destination indicates a travel time as a numerical value. The unit of a travel time is the “minute.” According to the table in FIG. 23, for example, a travel time to the stricken place 8B by the rescue squad 7A is 6 minutes.

In the fifth case, each place suffers a certain loss per unit time until a rescue squad moves to a place the squad is in charge of. It is presupposed that a magnitude of a loss per unit time is previously known. FIG. 24 illustrates a table indicating a loss per unit time at each place until a rescue squad arrives. For example, at the stricken place 8A, a loss per unit time until a rescue squad arrives is “−3.” For example, a value indicating a loss may be expressed by a negative number as indicated in the table in FIG. 24. A value indicating a loss may be a value based on any indicator. However, it is presupposed that a smaller value, that is, a larger absolute value, indicates a larger loss.

By a rescue squad moving to a stricken place, a loss disappears (that is, becomes 0). In other words, the rescue squad provides a benefit equivalent to an absolute value of the loss at the place.

Under such conditions, the transportation planning device 12 devises a transportation method of rescue squads, that is, a combination of transportation destinations of the respective rescue squads, minimizing a loss as a whole.

The condition acquisition unit 120 acquires various types of information as described above.

The candidate derivation unit 121 derives a candidate of a transportation method on the basis of acquired information. In this example, the following three candidates are derived.

Candidate (1): The rescue squad 7A moves to the stricken place 8A, and the rescue squads 7B and 7C move to the stricken places 8B and 8C, respectively.

Candidate (2): The rescue squad 7A moves to the stricken place 8B, and the rescue squads 7B and 7C move to the stricken places 8A and 8C, respectively.

Candidate (3): The rescue squad 7A moves to the stricken place 8C, and the rescue squads 7B and 7C move to the stricken places 8A and 8B, respectively.

According to the conditions in the example described here, the rescue squads 7B and 7C do not have an essential difference and therefore are not distinguished.

In order to derive the aforementioned candidates, the candidate derivation unit 121 may derive a combination of each rescue squad and each stricken place.

The calculation unit 122 calculates a rating for each derived candidate. For example, a rating is efficiency of an effect when the candidate is employed. For example, a rating in the fifth case is a magnitude of a loss generated at each stricken place. Specifically, for example, the calculation unit 122 calculates the total sum of magnitudes of losses at the respective stricken places on the basis of a chronological change in a loss at each stricken place (at what point the loss disappears). The total sum of magnitudes of losses at the respective stricken places is one of measures indicating efficiency of an overall benefit.

Under the conditions indicated in this description, a loss at each stricken place is the product of a time until a rescue squad arrives and a loss per minute.

In the case of the candidate (1), a loss at the stricken place 8A is (−3)×2=−6, a loss at the stricken place 8B is (−8)×7=−56, and a loss at the stricken place 8C is (−5)×9=−45, and therefore the total sum of the losses is “−107.”

In the case of the candidate (2), a loss at the stricken place 8A is (−3)×4=−12, a loss at the stricken place 8B is (−8)×6=−48, and a loss at the stricken place 8C is (−5)×9=−45, and therefore the total sum of the losses is “−105.”

In the case of the candidate (3), a loss at the stricken place 8A is (−3)×4=−12, a loss at the stricken place 8B is (−8)×7=−56, and a loss at the stricken place 8C is (−5)×8=−40, and therefore the total sum of the losses is “−108.”

The output unit 123 outputs information based on a rating. For example, the output unit 123 displays the total sum of losses by the respective candidates as a rating. A greater rating value, that is, a smaller absolute value of the total sum of losses represents a smaller damage. In other words, a candidate with a large rating value is a transportation method with high overall efficiency providing a large total benefit.

A content and a method of an output by the output unit 123 may be similar to the content and the method described in the first example embodiment.

The output unit 123 may output information specifying a candidate with a minimum absolute value of the total sum of losses as a “transportation method to be executed.” In the case of the example described above, a candidate with the minimum total sum of absolute values of losses is the candidate (2).

By applying the transportation planning device 12 to the fifth case, the rescue squads can move in such a way as to minimize an absolute value of the total sum of losses generated at the respective stricken places.

Note that when a travel time is considered as a cost, the candidate (2) is neither a candidate with the minimum transportation cost nor a candidate completing a transportation of each movable body earliest. A technique of deriving a transportation method with a minimum transportation cost when a travel time is considered as a cost derives the candidate (1). A technique of deriving a transportation method completing a transportation of each movable body earliest derives the candidate (3).

Various items described in the first example embodiment may be applied to and interpreted in the present example embodiment as much as possible. For example, the candidate derivation unit 121 in the transportation planning device 12 does not need to derive every candidate. In this case, a transportation method output as a “transportation method to be executed” may not necessarily be an optimum solution; however, as long as the transportation method is a transportation method derived out of sufficient candidates, the transportation method is expected to be a transportation method with a certain level of efficiency.

### Third Example Embodiment

A third example embodiment of the present invention is hereinafter described. According to the third example embodiment, a transportation planning device 10 performs transportation planning.

The transportation planning device 10 plans a transportation procedure of transportation targets which are part of or all of a plurality of resources. The transportation procedure is a procedure of changing an allocation of the plurality of resources from a first allocation to a second allocation.

A “resource” in the present disclosure refers to an entity generating or acquiring a benefit according to a given environment, or varying a magnitude of a specific benefit. For example, a resource may be a person or a robot.

A “benefit” in the present disclosure is not limited to a monetary profit. For example, a benefit may be a production amount of a thing, a reduced amount of a loss, a satisfaction level of a person, a happiness level, a frequency of occurrence or a probability of occurrence of a specific event, a rate of fluctuation of a specific value, or the like. A benefit has only to be a parameter, which is quantified on the basis of a defined measure, related to a matter of some value.

Information required for planning of a transportation procedure may be acquired from, for example, a unit (unillustrated) inside the transportation planning device 10, a device outside the transportation planning device 10, or a user of the transportation planning device 10.

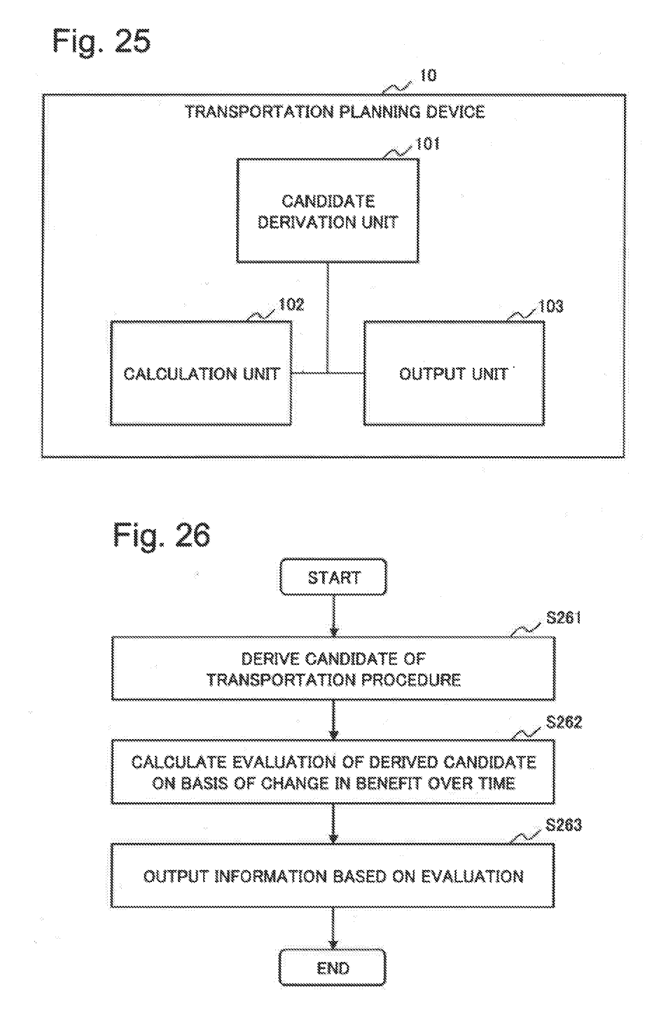

FIG. 25 is a block diagram illustrating a configuration of the transportation planning device 10. The transportation planning device 10 includes a candidate derivation unit 101, a calculation unit 102, and an output unit 103.

The candidate derivation unit 101 derives a candidate of a transportation procedure. The candidate derivation unit 111 and the candidate derivation unit 121 are examples of the candidate derivation unit 101.

The calculation unit 102 calculates a rating of the derived candidate on the basis of a chronological change in a benefit generated by a plurality of resources when the candidate is executed. A chronological change in a benefit is specified on the basis of a time required for each of the transportation targets to move to an individual transportation destination and an effect of the transportation by the transportation targets. A time required for a transportation is a time for a transportation. Specifically, a time required for a transportation refers to a time until a transportation target changes a benefit at a transportation destination from status in which the transportation target is actually placed. For example, an effect of a transportation by a transportation target refers to a magnitude of a change in a benefit due to completion of the transportation by the transportation target. The calculation unit 112 and the calculation unit 122 are examples of the calculation unit 102.

The output unit 103 outputs information based on the rating. The output unit 113 and the output unit 123 are examples of the output unit 103.

Next, referring to a flowchart in FIG. 26, an operation flow of units in the transportation planning device 10 is described.

First, the candidate derivation unit 101 derives a candidate of a transportation procedure (Step S261). Next, the calculation unit 102 calculates a rating of the derived candidate on the basis of a chronological change in a benefit generated by a plurality of resources when the candidate is executed (Step S262). Then, the output unit 103 outputs information based on the rating (Step S263).

The transportation planning device 10 according to the third example embodiment outputs information related to a transportation procedure of resources for changing a resource allocation from a first allocation to a second allocation. The output unit 103 may output, as information based on a rating, information specifying a candidate with the highest rating out of derived candidates. Since the rating is calculated on the basis of a chronological change in a benefit, a candidate with a higher rating may be a transportation procedure with a larger magnitude of a benefit. In this case, resources can execute a transportation procedure with a larger magnitude of a benefit.

When the candidate derivation unit 101 derives every transportation procedure that may have the highest rating, the output unit 103 can output a transportation procedure that provides a maximized magnitude of a benefit. Accordingly, in this case, resources can change an allocation from a first allocation to a second allocation by a procedure that results in a maximized benefit.

### Modified Example

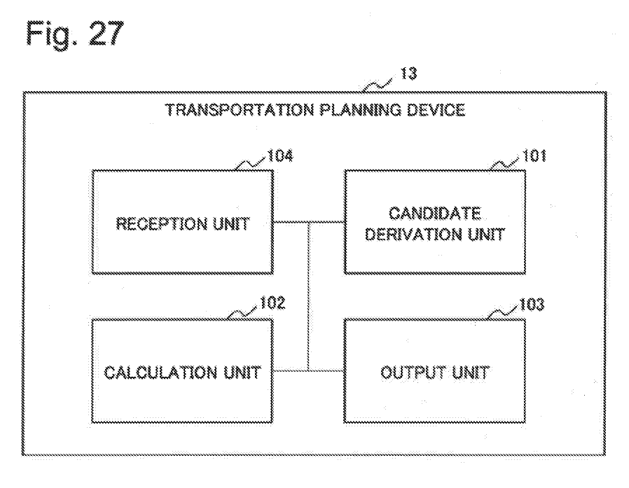

A transportation planning device 13 which is a device acquired by further including a reception unit 104 in the transportation planning device 10 is described below. FIG. 27 is a block diagram illustrating a configuration of the transportation planning device 13. The transportation planning device 13 includes the reception unit 104, a candidate derivation unit 101, a calculation unit 102, and an output unit 103.

The reception unit 104 receives an input of a transportation procedure. The transportation method reception unit described in Supplement [6] in the first example embodiment is an example of the reception unit 104.

The candidate derivation unit 101 derives a candidate of a transportation procedure of in which an allocation after execution of the received transportation procedure under a presumption that the received transportation procedure is executed is regarded as the second allocation.

The calculation unit 102 calculates a rating of the received transportation procedure and a rating of the derived candidate.

The output unit 103 outputs information based on a comparison between the rating of the received transportation procedure and the rating of the derived candidate. An example of information based on a comparison is the information described in Supplement [6] in the first example embodiment.

With such a configuration, information about a transportation procedure that may replace a transportation procedure input to the reception unit 104 in the transportation planning device 13 is provided. For example, when the output unit 103 outputs a candidate with a higher rating than a rating of a received transportation procedure, resources can change an allocation by a transportation procedure more efficient than the received transportation procedure.

### Supplement

A concept of a “transportation” described above may be developed to and interpreted as a concept of a “transition.” In other words, a transportation planning problem handled by the transportation planning device 11 does not necessarily need to be a problem related to “changing a spatial position.” For example, a concept of that “a worker moves from the section 5A to the section 5B on changing an allocation of workers from a certain allocation to another allocation” according to the first example embodiment, may be read as a concept of that “a worker transitions from a specific operation ‘A’ to a specific operation ‘B’ on changing a combination of a worker and operation details from a certain combination to another combination.” In other words, even in a case that the specific operation ‘A’ and the specific operation ‘B’ are operations executable in the spatially same position, when it takes time for a transition between the operations, the transportation planning device 11 can process a problem of deriving a suitable transition method by regarding the problem as a problem identical to transportation planning. Accordingly, the concept of a “transportation” in the present disclosure may contain not only a meaning of “changing a spatial position” but also meanings of “changing operation details,” “changing situation which resources (such as workers) are in,” and “changing a target for which a benefit is provided.” In other words, “transportation” used in the present disclosure may be interpreted to contain a meaning of “transition.”

### Configuration of Hardware for Achieving Elements of Example Embodiments

In each example embodiment of the present invention described above, components of each device indicate blocks on a functional basis.

The processing of each element may be performed, for example, by a computer system reading and executing a program stored in a computer-readable storage medium. The program may cause the computer system to perform the processing. The “computer-readable storage medium” indicates a portable medium such as an optical disc, a magnetic disc, a magneto-optical disc, and a nonvolatile semiconductor memory, and a storage device such as a read only memory (ROM) and a hard disk embedded in the computer system. The “computer-readable recording medium” also includes a medium for dynamically holding a program for a short time period such as a communication line in the case in which the program is transmitted via a network such as the Internet or a communication line such as a telephone line, and a medium for temporarily holding the program such as a volatile memory in the computer system serving as a server or a client in that case. The aforementioned program may also be a program for performing some of the aforementioned functions, or a program capable of performing the aforementioned functions in combination with a program previously stored in the computer system.

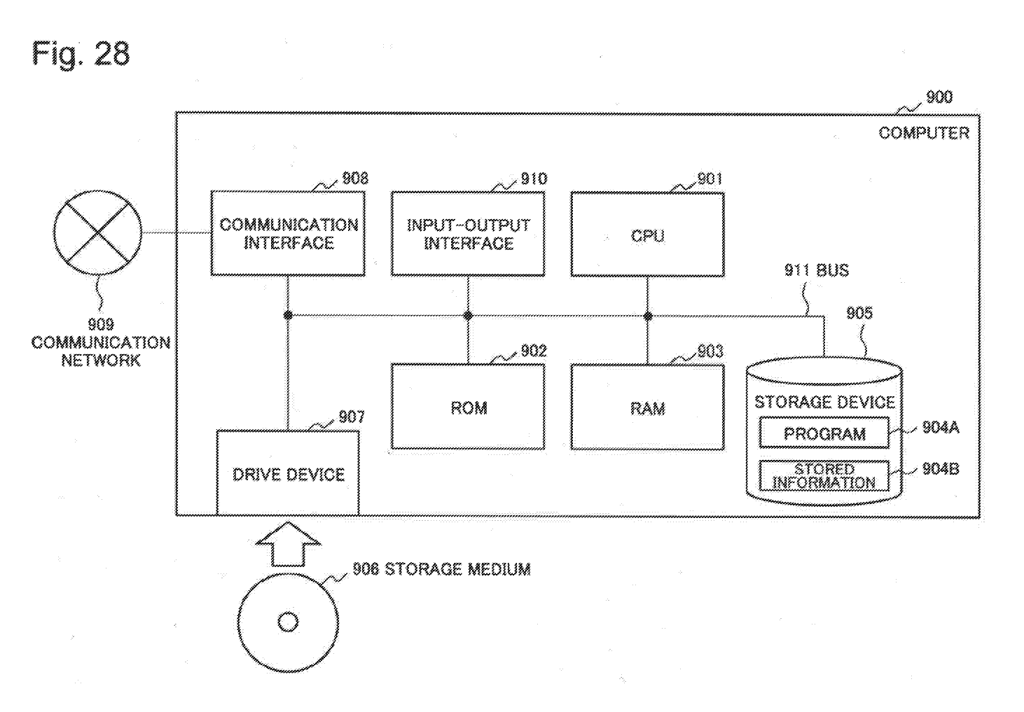

The “computer system” is, for example, a system including a computer 900 illustrated in FIG. 28. The computer 900 includes the following elements.
a central processing unit (CPU) 901
a read only memory (ROM) 902
a random access memory (RAM) 903
a program 904A and stored information 904B loaded to the RAM 903
a storage device 905 storing the program 904A and stored information 904B
a drive device 907 reading and writing from and to a recording medium 906
a communication interface 908 connected with a communication network 909
an input/output interface 910 inputting and outputting data
a bus 911 connecting the respective components

Components of each device according to each example embodiment are achieved by loading, into the RAM 903, and executing, by the CPU 901, the program 904A for achieving functions thereof. The program 904A for achieving the functions of the components of each device is stored in, for example, the storage device 905 or in the ROM 902 in advance. The CPU 901 reads the program as needed. The program 904A may be supplied to the CPU 901 via the communication network 909, or the program stored in the recording medium 906 in advance may be read by the drive device 907 and supplied to the CPU 901. The recording medium 906 may be, for example, a portable medium such as an optical disc, a magnetic disc, a magneto-optical disc, and a nonvolatile semiconductor memory.

There are various modification examples of a method of implementing each device. For example, each of the devices may be achieved by applicable combinations of the computer 1900 and a program individually implemented for each component. Further, a plurality of components included in the device may be achieved by an applicable combination of one computer 1900 and a program.

Some or all of components of each device are implemented by another general-purpose or dedicated circuit, a computer, or the like, or by a combination thereof. These components may be achieved by a single chip, or may be achieved by a plurality of chips connected via a bus.

When some or all of components of each device are implemented by a plurality of computers, circuits, or the like, the plurality of computers, circuits, or the like may be centralizedly arranged, or may be dispersedly arranged. For example, computers, circuits, or the like may be implemented as a mode, such as a client and server system or a cloud computing system, in which the computers, circuits, or the like are mutually connected via a communication network.

The present invention has been described above by use of the example embodiments; however, the technical scope of the present invention is not limited to the aforementioned example embodiments. It is obvious to a person skilled in the art that various changes or modifications can be made to the aforementioned example embodiments. It is obvious from matters described in the claims that an example embodiment with such changes or modifications may also be included in the technical scope of the present invention.

All or part of the example embodiments described above may be described as in the following supplementary notes, but the present invention is not limited thereto.

(Supplementary Note 1)

A transportation planning device comprising:
candidate derivation means for deriving one or more candidates of a transportation procedure of one or more transportation targets which are part or all of a plurality of resources, the transportation procedure being a procedure of changing an allocation of the plurality of resources from a first allocation to a second allocation;
calculation means for calculating a rating of the derived candidate, based on a chronological change in a benefit generated by the plurality of resources when the candidate is executed, the chronological change in the benefit being specified based on a time required for each of the one or more transportation targets to move to an individual transportation destination; and
output means for outputting information based on the rating.

(Supplementary Note 2)

The transportation planning device according to Supplementary Note 1, wherein
the rating is a value dependent on a benefit generated by the resource at each transportation destination, and
when a magnitude of the benefit at at least one of the transportation destinations is affected by a magnitude of the benefit generated at at least one of positions where the plurality of resources are allocated, the calculation means specifies the chronological change, based on a magnitude of the benefit based on existence or nonexistence of the effect, on calculation of the rating.

(Supplementary Note 3)

The transportation planning device according to Supplementary Note 1 or 2, wherein
with respect to at least one position included in positions where the plurality of resources are allocated under the first allocation, in a case that a benefit in the position does not decline even when the resource in the position under the first allocation decreases, the candidate derivation means counts in the resource in the position as a resource that may become one of the one or more transportation targets.

(Supplementary Note 4)

The transportation planning device according to any one of Supplementary Notes 1 to 3, wherein,
with respect to at least one position included in positions where the plurality of resources are allocated under the first allocation, when a difference between a magnitude of a benefit per resource in a case that a resource in the position decreases and a magnitude of a benefit per resource under the second allocation is less than a total sum of a difference between a magnitude of a benefit per resource under the first allocation and a magnitude of a benefit per resource in the second allocation in each position where a number of resources increases between the first allocation and the second allocation, the candidate derivation means counts in the resource in the position as the resource that may become one of the one or more transportation targets.

(Supplementary Note 5)

The transportation planning device according to any one of Supplementary Notes 1 to 4, wherein
information based on the rating includes information indicating the candidate with the rating being highest out of the derived one or more candidates.

(Supplementary Note 6)

The transportation planning device according to any one of Supplementary Notes 1 to 5, wherein
the output means outputs a transportation instruction for the one or more transportation targets to move to the individual transportation destination in accordance with a procedure indicated by the candidate with the rating being highest out of the derived candidates.

(Supplementary Note 7)

The transportation planning device according to any one of Supplementary Notes 1 to 6, wherein
the candidate derivation means
extracts a candidate of the transportation destination and a candidate of the one or more transportation targets,
generates the transportation procedure by combination of the candidate of the one or more transportation targets and the candidate of the transportation destination, and
derives the transportation procedure that may be generated by the combination as a candidate of the transportation procedure while excluding the transportation procedure the rating of which is obviously not highest out of one or more of transportation procedures that may be generated by the combination, based on a time required for the candidate of the one or more transportation targets to move to an individual candidate of the transportation destination.

(Supplementary Note 8)

The transportation planning device according to any one of Supplementary Notes 1 to 7, wherein,
out of one or more of transportation procedures including a procedure of a first resource moving to a first transportation destination and a procedure of a second resource moving from the first transportation destination to a second transportation destination, the candidate derivation means does not derive, as the candidate the rating of which is calculated by the calculation means, a transportation procedure in which a time required for a transportation to the second transportation destination by the second resource is longer than a time required for a transportation to the second transportation destination by the first resource.

(Supplementary Note 9)

The transportation planning device according to any one of Supplementary Notes 1 to 8, further comprising
reception means for receiving an input of a transportation procedure, wherein
the candidate derivation means derives the one or more candidates of the transportation procedure in which an allocation after execution of the received transportation procedure under a presumption that the received transportation procedure is executed is regarded as the second allocation, and
the output means outputs information based on a comparison between the rating of the received transportation procedure and the rating of the derived one or more candidates.

(Supplementary Note 10)

The transportation planning device according to any one of Supplementary Notes 1 to 9, further comprising
condition acquisition means for acquiring efficiency information indicating a relation between a number of resources and a magnitude of the benefit, time information indicating a time required for the resources to move to each of positions where the plurality of resources are allocated under the second allocation, and information by which the first allocation and the second allocation can be specified.

(Supplementary Note 11)

A transportation planning device comprising:
candidate derivation means for deriving a candidate of a transition procedure in which situations of one or more transition targets which are part or all of a plurality of resources are changed, the transition procedure being a procedure of changing a combination of situations which the plurality of resources is in, from a first combination to a second combination;
calculation means for calculating a rating of the derived candidate, based on a chronological change in a benefit generated by the plurality of resources when the candidate is executed, the chronological change in the benefit being specified based on a time required for each of the one or more transition targets to transition to individual transition destination of a situation; and
output means for outputting information based on the rating.

(Supplementary Note 12)

A transportation planning method comprising:
deriving one or more candidates of a transportation procedure of one or more transportation targets which are part or all of a plurality of resources, the transportation procedure being a procedure of changing an allocation of the plurality of resources from a first allocation to a second allocation;
calculating a rating of the derived candidate, based on a chronological change in a benefit generated by the plurality of resources when the candidate is executed, the chronological change in the benefit being specified based on a time required for each of the one or more transportation targets to move to an individual transportation destination; and outputting information based on the rating.

(Supplementary Note 13)

The transportation planning method according to Supplementary Note 12, wherein
the rating is a value dependent on a benefit generated by the resource at each transportation destination, and
the transportation planning method comprises specifying, when a magnitude of the benefit at at least one of the transportation destinations is affected by a magnitude of the benefit generated at at least one of positions where the plurality of resources are allocated, the chronological change, based on a magnitude of the benefit based on existence or nonexistence of the effect, on calculation of the rating.

(Supplementary Note 14)

The transportation planning method according to Supplementary Note 12 or 13, wherein
in derivation of the one or more candidates, with respect to at least one position included in positions where the plurality of resources are allocated under the first allocation, in a case that a benefit in the position does not decline even when the resource in the position under the first allocation decreases, the transportation planning method comprises counting in the resource in the position as a resource that may become one of the one or more transportation targets.

(Supplementary Note 15)

The transportation planning method according to any one of Supplementary Notes 12 to 14, wherein,
in derivation of the one or more candidates, with respect to at least one position included in positions where the plurality of resources are allocated under the first allocation, when a difference between a magnitude of a benefit per resource in a case that a resource in the position decreases and a magnitude of a benefit per resource under the second allocation is less than a total sum of a difference between a magnitude of a benefit per resource under the first allocation and a magnitude of a benefit per resource in the second allocation in each position where a number of resources increases between the first allocation and the second allocation, the transportation planning method comprises counting in the resource in the position as the resource that may become one of the one or more transportation targets.

(Supplementary Note 16)

The transportation planning method according to any one of Supplementary Notes 12 to 15, wherein
information based on the rating includes information indicating the candidate with the rating being highest out of the derived one or more candidates.

(Supplementary Note 17)

The transportation planning method according to any one of Supplementary Notes 12 to 16, comprising
outputting a transportation instruction for the one or more transportation targets to move to the individual transportation destination in accordance with a procedure indicated by the candidate with the rating being highest out of the derived candidates.

(Supplementary Note 18)

The transportation planning method according to any one of Supplementary Notes 12 to 17, wherein
the deriving the one or more candidates comprises:
extracting a candidate of the transportation destination and a candidate of the one or more transportation targets;
generating the transportation procedure by combination of the candidate of the one or more transportation targets and the candidate of the transportation destination; and
deriving the transportation procedure that may be generated by the combination as a candidate of the transportation procedure while excluding the transportation procedure the rating of which is obviously not highest out of one or more of transportation procedures that may be generated by the combination, based on a time required for the candidate of the one or more transportation targets to move to an individual candidate of the transportation destination.

(Supplementary Note 19)

The transportation planning method according to any one of Supplementary Notes 12 to 18, wherein,
in derivation of the one or more candidates, out of one or more of transportation procedures including a procedure of a first resource moving to a first transportation destination and a procedure of a second resource moving from the first transportation destination to a second transportation destination, the derivation does not derive, as the candidate the rating of which is calculated, a transportation procedure in which a time required for a transportation to the second transportation destination by the second resource is longer than a time required for a transportation to the second transportation destination by the first resource.

(Supplementary Note 20)

The transportation planning method according to any one of Supplementary Notes 12 to 19, further comprising:
receiving an input of a transportation procedure;
deriving the one or more candidates of the transportation procedure in which an allocation after execution of the received transportation procedure under a presumption that the received transportation procedure is executed is regarded as the second allocation;
calculating a rating of the received transportation procedure and the rating of the derived candidate; and
outputting information based on a comparison between the rating of the received transportation procedure and the rating of the derived one or more candidates.

(Supplementary Note 21)

The transportation planning method according to any one of Supplementary Notes 12 to 20, further comprising
acquiring efficiency information indicating a relation between a number of resources and a magnitude of the benefit, time information indicating a time required for the resources to move to each of positions where the plurality of resources are allocated under the second allocation, and information by which the first allocation and the second allocation can be specified.

(Supplementary Note 22)

A transportation planning method comprising:
deriving a candidate of a transition procedure in which situations of one or more transition targets which are part or all of a plurality of resources are changed, the transition procedure being a procedure of changing a combination of situations which the plurality of resources is in, from a first combination to a second combination;
calculating a rating of the derived candidate, based on a chronological change in a benefit generated by the plurality of resources when the candidate is executed, the chronological change in the benefit being specified based on a time required for each of the one or more transition targets to transition to individual transition destination of a situation; and
outputting information based on the rating.

(Supplementary Note 23)

A computer-readable storage medium storing a program that causes a computer to execute:
candidate derivation processing for deriving one or more candidates of a transportation procedure of one or more transportation targets which are part or all of a plurality of resources, the transportation procedure being a procedure of changing an allocation of the plurality of resources from a first allocation to a second allocation;
calculation processing for calculating a rating of the derived candidate, based on a chronological change in a benefit generated by the plurality of resources when the candidate is executed, the chronological change in the benefit being specified based on a time required for each of the one or more transportation targets to move to an individual transportation destination; and
output processing for outputting information based on the rating.

(Supplementary Note 24)

The storage medium according to Supplementary Note 23, wherein
the rating is a value dependent on a benefit generated by the resource at each transportation destination, and
when a magnitude of the benefit at at least one of the transportation destinations is affected by a magnitude of the benefit generated at at least one of positions where the plurality of resources are allocated, the calculation processing specifies the chronological change, based on a magnitude of the benefit based on existence or nonexistence of the effect, on calculation of the rating.

(Supplementary Note 25)

The storage medium according to Supplementary Note 23 or 24, wherein
with respect to at least one position included in positions where the plurality of resources are allocated under the first allocation, in a case that a benefit in the position does not decline even when the resource in the position under the first allocation decreases, the candidate derivation processing counts in the resource in the position as a resource that may become one of the one or more transportation targets.

(Supplementary Note 26)

The storage medium according to any one of Supplementary Notes 23 to 25, wherein,
with respect to at least one position included in positions where the plurality of resources are allocated under the first allocation, when a difference between a magnitude of a benefit per resource in a case that a resource in the position decreases and a magnitude of a benefit per resource under the second allocation is less than a total sum of a difference between a magnitude of a benefit per resource under the first allocation and a magnitude of a benefit per resource in the second allocation in each position where a number of resources increases between the first allocation and the second allocation, the candidate derivation processing counts in the resource in the position as the resource that may become one of the one or more transportation targets.

(Supplementary Note 27)
The storage medium according to any one of Supplementary Notes 23 to 26, wherein
information based on the rating includes information indicating the candidate with the rating being highest out of the derived one or more candidates.

(Supplementary Note 28)

The storage medium according to any one of Supplementary Notes 23 to 27, wherein
the output processing outputs a transportation instruction for the one or more transportation targets to move to the individual transportation destination in accordance with a procedure indicated by the candidate with the rating being highest out of the derived candidates.

(Supplementary Note 29)

The storage medium according to any one of Supplementary Notes 23 to 28, wherein
the candidate derivation processing
extracts a candidate of the transportation destination and a candidate of the one or more transportation targets,
generates the transportation procedure by combination of the candidate of the one or more transportation targets and the candidate of the transportation destination, and
derives the transportation procedure that may be generated by the combination as a candidate of the transportation procedure while excluding the transportation procedure the rating of which is obviously not highest out of one or more of transportation procedures that may be generated by the combination, based on a time required for the candidate of the one or more transportation targets to move to an individual candidate of the transportation destination.

(Supplementary Note 30)

The storage medium according to any one of Supplementary Notes 23 to 29, wherein,
out of one or more of transportation procedures including a procedure of a first resource moving to a first transportation destination and a procedure of a second resource moving from the first transportation destination to a second transportation destination, the candidate derivation processing does not derive, as the candidate the rating of which is calculated by the calculation processing, a transportation procedure in which a time required for a transportation to the second transportation destination by the second resource is longer than a time required for a transportation to the second transportation destination by the first resource.

(Supplementary Note 31)

The storage medium according to any one of Supplementary Notes 23 to 30, wherein
the storage medium stores the program that further causes the computer to execute reception processing for receiving an input of a transportation procedure,
the candidate derivation processing derives the one or more candidates of the transportation procedure in which an allocation after execution of the received transportation procedure under a presumption that the received transportation procedure is executed is regarded as the second allocation, and
the output processing outputs information based on a comparison between the rating of the received transportation procedure and the rating of the derived one or more candidates.

(Supplementary Note 32)

The storage medium according to any one of Supplementary Notes 23 to 31, wherein the storage medium stores the program that further causes the computer to execute
condition acquisition processing for acquiring efficiency information indicating a relation between a number of resources and a magnitude of the benefit, time information indicating a time required for the resources to move to each of positions where the plurality of resources are allocated under the second allocation, and information by which the first allocation and the second allocation can be specified.

(Supplementary Note 33)

A computer-readable storage medium storing a program that causes a computer to execute:
candidate derivation processing for deriving a candidate of a transition procedure in which situations of one or more transition targets which are part or all of a plurality of resources are changed, the transition procedure being a procedure of changing a combination of situations which the plurality of resources is in, from a first combination to a second combination;
calculation processing for calculating a rating of the derived candidate, based on a chronological change in a benefit generated by the plurality of resources when the candidate is executed, the chronological change in the benefit being specified based on a time required for each of the one or more transition targets to transition to individual transition destination of a situation; and output processing for outputting information based on the rating.

### Reference Signs List

E1 work environment

E5 application environment

2 worker

3 conveyor

4 container

5A, 5B, 5C, 5D section

7 movable body

8 area

9 user

10˜13 transportation planning device

110, 120 condition acquisition unit

101, 111, 121 candidate derivation unit

102, 112, 122 calculation unit

103, 113, 123 output unit

104 reception unit

900 computer

901 CPU

902 ROM

903 RAM

904A program

904B stored information

905 storage device

906 recording medium

907 drive device

908 communication interface

909 communication network

910 input/output interface

911 bus

What is claimed is:

1. A transportation planning device comprising:
at least one memory storing instructions; and
at least one processor coupled to the at least one memory, the at least one processor being configured to execute the instructions to execute:
candidate derivation processing comprising deriving one or more candidates of a transportation procedure of one or more transportation targets which are part or all of a plurality of resources, the transportation procedure being a procedure of changing an allocation of the plurality of resources from a first allocation to a second allocation;
calculation processing comprising calculating a rating of a candidate included in the one or more candidates, based on a chronological change in a benefit generated by the plurality of resources when the candidate is executed, the chronological change in the benefit being specified based on a time required for each of the one or more transportation targets to move to an individual transportation destination; and
output processing comprising outputting information based on the rating.

2. The transportation planning device according to claim 1, wherein
the rating is a value dependent on a benefit generated by the plurality of resources at each of one or more transportation destinations which are destinations for the respective one or more transportation targets, and
when a magnitude of the benefit at at least one of the one or more transportation destinations is affected by a magnitude of the benefit generated at at least one of positions where the plurality of resources are allocated, the calculation processing specifies the chronological change, based on a magnitude of the benefit based on existence or nonexistence of the effect, on calculation of the rating.

3. The transportation planning device according to claim 1, wherein
with respect to at least one position included in positions where the plurality of resources are allocated under the first allocation, in a case that a benefit in the position does not decline even when the resource in the position under the first allocation decreases, the candidate derivation processing counts in the resource in the position as a resource that may become one of the one or more transportation targets.

4. The transportation planning device according to claim 1, wherein,
with respect to at least one position included in positions where the plurality of resources are allocated under the first allocation, when a difference between a magnitude of a benefit per resource in a case that a resource in the position decreases and a magnitude of a benefit per resource under the second allocation is less than a total sum of a difference between a magnitude of a benefit per resource under the first allocation and a magnitude of a benefit per resource in the second allocation in each position where a number of resources increases between the first allocation and the second allocation, the candidate derivation processing counts in the resource in the position as the resource that may become one of the one or more transportation targets.

5. The transportation planning device according to claim 1, wherein
information based on the rating includes information indicating the candidate with the rating being highest out of the derived one or more candidates.

6. The transportation planning device according to claim 1, wherein
the output processing outputs transportation instruction information for each of the one or more transportation targets to move to the individual transportation destination in accordance with a procedure indicated by the candidate with the rating being highest out of the derived candidates.

7. The transportation planning device according to claim 1, wherein
the candidate derivation processing
extracts a candidate of the transportation destination and a candidate of the one or more transportation targets,
generates the transportation procedure by combination of the candidate of the one or more transportation targets and the candidate of the transportation destination, and
derives the transportation procedure that may be generated by the combination as a candidate of the transportation procedure while excluding the transportation procedure the rating of which is obviously not highest out of one or more of transportation procedures that may be generated by the combination, based on a time required for the candidate of the one or more transportation targets to move to an individual candidate of the transportation destination.

8. The transportation planning device according to claim 1, wherein,
out of one or more of transportation procedures including a procedure of a first resource moving to a first transportation destination and a procedure of a second resource moving from the first transportation destination to a second transportation destination, the candidate derivation processing does not derive, as the candidate the rating of which is calculated by the calculation processing, a transportation procedure in which a time required for a transportation to the second transportation destination by the second resource is longer than a time required for a transportation to the second transportation destination by the first resource.

9-11. (canceled)

12. A transportation planning method comprising:
deriving one or more candidates of a transportation procedure of one or more transportation targets which are part or all of a plurality of resources, the transportation procedure being a procedure of changing an allocation of the plurality of resources from a first allocation to a second allocation;
calculating a rating of a candidate included in the one or more candidates, based on a chronological change in a benefit generated by the plurality of resources when the candidate is executed, the chronological change in the benefit being specified based on a time required for each of the one or more transportation targets to move to an individual transportation destination; and
outputting information based on the rating.

13-22. (canceled)

23. A non-transitory computer-readable storage medium storing a program that causes a computer to execute:
candidate derivation processing for deriving one or more candidates of a transportation procedure of one or more transportation targets which are part or all of a plurality of resources, the transportation procedure being a procedure of changing an allocation of the plurality of resources from a first allocation to a second allocation;
calculation processing for calculating a rating of a candidate included in the one or more candidates, based on a chronological change in a benefit generated by the plurality of resources when the candidate is executed, the chronological change in the benefit being specified based on a time required for each of the one or more transportation targets to move to an individual transportation destination; and
output processing for outputting information based on the rating.

24-33. (canceled)
